(19) United States
(12) Patent Application Publication
(10) Pub. No.: US 2022/0365879 A1
(43) Pub. Date: Nov. 17, 2022

(54) Throttling Schemes in Multicore Microprocessors

(71) Applicant: Nuvia, Inc., San Diego, CA (US)

(72) Inventors: Amit Kumar, Fremont, CA (US); Conrado Blasco, San Mateo, CA (US)

(21) Appl. No.: 17/591,134

(22) Filed: Feb. 2, 2022

Related U.S. Application Data
(60) Provisional application No. 63/187,232, filed on May 11, 2021.
(60) Provisional application No. 63/187,241, filed on May 11, 2021.

(51) Int. Cl. G06F 12/0875; G06F 9/38

(52) U.S. Cl. CPC G06F 12/0875; G06F 9/3802; G06F 2212/452

(57) ABSTRACT

An electronic device includes a cache, a processing cluster having one or more processors, and prefetch throttling circuitry that determines a congestion level of the processing cluster based on an extent to which the data retrieval requests sent from the processors to the cache are not satisfied by the cache. Congestion criteria require that the congestion level of the cluster is above a cluster congestion threshold. In accordance with a determination that the congestion level of the cluster satisfies the congestion criteria, the prefetch throttling circuit causes one of the processors to limit prefetch requests to the cache to prefetch requests of at least a threshold quality. In accordance with a determination that the congestion level of the cluster does not satisfy the congestion criteria, the prefetch throttling circuit forgoes causing the processors to limit prefetch requests to the cache to prefetch requests of at least the threshold quality.

### RELATED APPLICATIONS

This application claims priority to U.S. Provisional Patent Application No. 63/187,232, titled “Throttling Schemes in Multicore Microprocessors,” filed on May 11, 2021, and U.S. Provisional Patent Application No. 63/187,241, titled “Throttling Schemes in Multicore Microprocessors,” filed on May 11, 2021, each of which is hereby incorporated by reference in its entirety.

### TECHNICAL FIELD

This application relates generally to microprocessor technology including, but not limited to, methods, systems, and devices for controlling cache prefetching in a processor cluster having multiple processors based on congestion levels of the processor cluster.

### BACKGROUND

Cache prefetching is applied in a microprocessor of a computer system to fetch instructions and data to be used from a slower memory or cache to a faster local cache to enhance execution performance of the microprocessor. Aggressive cache prefetching may provide a significant performance uplift for the microprocessor at a risk of causing cache pollution in the faster local cache that often has a limited capacity. In the context of a processor cluster (i.e., a multicore microprocessor), a large amount of traffic exists to facilitate regular memory accesses required by operations of individual processor units, which makes it difficult for the processor cluster to spare additional bandwidth to manage cache prefetching for the processor units. Cache prefetching can easily conflict with the regular memory accesses required by the operations of the processors. As such, it would be highly desirable to provide an electronic device or system that manages cache prefetching efficiently for a processor cluster having multiple processors.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of some implementations are used to monitor multiple cluster and system congestion levels and control cache prefetching in a processor cluster based on the monitored congestion levels. In some implementations, an electronic device is provided with a cache, a processing cluster having one or more processors, and prefetch throttling circuitry that is configured to determine a cluster congestion level of the processing cluster based on an extent to which data retrieval requests sent from the processors to the cache are not satisfied by the cache and control prefetch requests to the cache in accordance with a determination whether the cluster congestion level of the processing cluster satisfies predefined congestion criteria. In some implementations, an electronic device is provided with first memory, second memory, a plurality of processing clusters, and prefetch throttling circuitry that is configured to cause a respective processing cluster to limit prefetch requests from the respective processing cluster based on a system congestion level associated with the first memory and/or the second memory.

In one aspect, an electronic device includes a first processing cluster, a cache, and prefetch throttling circuitry. The first processing cluster further includes one or more processors. The cache is coupled to the one or more processors in the first processing cluster, and is configured to receive, from the one or more processors in the first processing cluster, a plurality of data retrieval requests including demand requests and prefetch requests. The prefetch throttling circuitry is coupled to the one or more processors in the first processing cluster, and is configured to determine a congestion level of the first processing cluster based on an extent to which the plurality of data retrieval requests sent from the one or more processors in the first processing cluster to the cache are not satisfied by the cache. The prefetch throttling circuitry is further configured to in accordance with a determination that the congestion level of the first processing cluster satisfies first congestion criteria that require that the congestion level of the first processing cluster is above a first cluster congestion threshold, cause a first respective processor of the one or more processors to limit prefetch requests to the cache to prefetch requests of at least a first threshold quality. The prefetch throttling circuitry is further configured to in accordance with a determination that the congestion level of the first processing cluster does not satisfy the first congestion criteria, forgo causing the one or more processors to limit prefetch requests to the cache to prefetch requests of at least the first threshold quality.

Further, in another aspect of the invention, an electronic device includes a plurality of processing clusters, first memory (e.g., a system cache coupled to the processing clusters), second memory (e.g., DRAM memory coupled to the system cache), and prefetch throttling circuitry. Each processing cluster further includes one or more respective processors. The first memory is coupled to the plurality of processing clusters, and the second memory is coupled to the plurality of processing clusters. The second memory is configured to receive data retrieval requests sent from the plurality of processing clusters to the first memory that are not satisfied by the first memory. The prefetch throttling circuitry is coupled to the one or more respective processors in each of the plurality of processing clusters. The electronic device is configured to obtain a current congestion level of the first memory based on a number of outstanding in-flight requests received by the first memory, and maintain a first congestion level history that includes the obtained current congestion level of the first memory. The electronic device is also configured to obtain a current congestion level of the second memory based on a number of outstanding in-flight requests received by the second memory, and maintain a second congestion level history that includes the obtained current congestion level of the second memory. The prefetch throttling circuitry is configured to cause a respective processing cluster to limit prefetch requests from the respective processing cluster based on at least one of the obtained current congestion level of the first memory and the obtained current congestion level of the second memory.

These illustrative embodiments and implementations are mentioned not to limit or define the disclosure, but to provide examples to aid understanding thereof. Additional embodiments are discussed in the Detailed Description, and further description is provided there. Other implementations and advantages may be apparent to those skilled in the art in light of the descriptions and drawings in this specification.

### BRIEF DESCRIPTION OF THE DRAWINGS

FIG. 1 is a block diagram of an example system module in a typical electronic device, in accordance with some implementations.

FIG. 2 is a block diagram of an example electronic device having one or more processing clusters, in accordance with some implementations.

FIG. 3 illustrates an example method of determining a congestion level of a processing cluster for controlling cache prefetching in the processing cluster, in accordance with some implementations.

FIG. 4 illustrates an example method of determining a system congestion level for controlling cache prefetching in an individual processing cluster, in accordance with some implementations.

FIG. 5A illustrates two tables showing definitions of quality thresholds associated with prefetch qualities of prefetches that are limited under different system congestion levels, in accordance with some implementations.

FIG. 5B illustrates two tables showing quality thresholds associated with stride history lengths of prefetches that are limited under different system congestion levels, in accordance with some implementations.

FIGS. 6A and 6B are data structures of data stored for a throttler (also called prefetch throttling circuitry) and a prefetcher, in accordance with some implementations, respectively.

FIG. 7 is a flow chart of an example method of controlling cache prefetching in a first processing cluster, in accordance with some implementations.

FIG. 8 is a flow chart of another example method of controlling cache prefetching in a processing cluster, in accordance with some implementations.

For a better understanding of the various described implementations, reference should be made to the Detailed Description below, in conjunction with the following drawings in which like reference numerals refer to corresponding parts throughout the figures. Like reference numerals refer to corresponding parts throughout the drawings.

### DESCRIPTION OF EMBODIMENTS

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details.

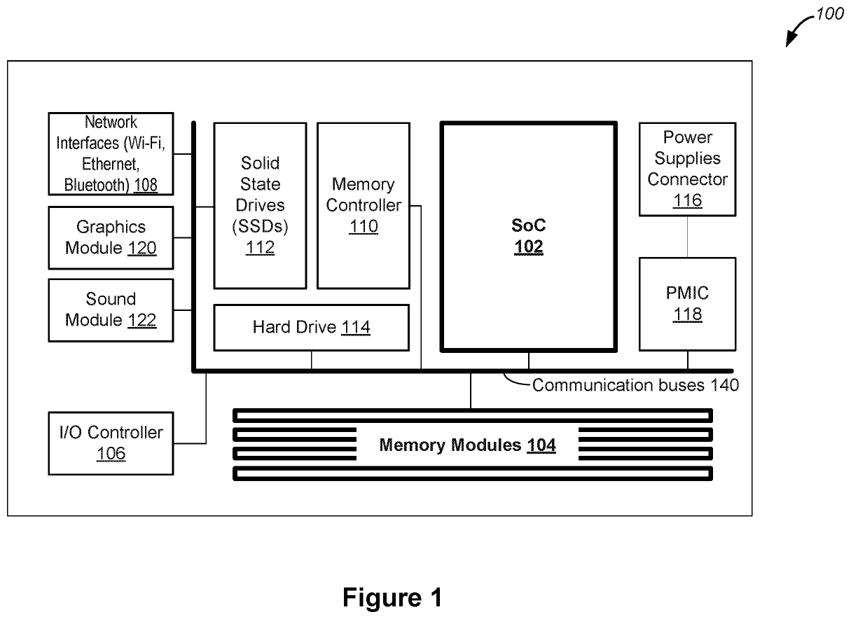

FIG. 1 is a block diagram of an example system module 100 in a typical electronic device in accordance with some implementations. System module 100 in this electronic device includes at least a system on a chip (SoC) 102, memory modules 104 for storing programs, instructions and data, an input/output (I/O) controller 106, one or more communication interfaces such as network interfaces 108, and one or more communication buses 140 for interconnecting these components. In some implementations, I/O controller 106 allows SoC 102 to communicate with an I/O device (e.g., a keyboard, a mouse or a track-pad) via a universal serial bus interface. In some implementations, network interfaces 108 includes one or more interfaces for Wi-Fi, Ethernet and Bluetooth networks, each allowing the electronic device to exchange data with an external source, e.g., a server or another electronic device. In some implementations, communication buses 140 include circuitry (sometimes called a chipset) that interconnects and controls communications among various system components included in system module 100.

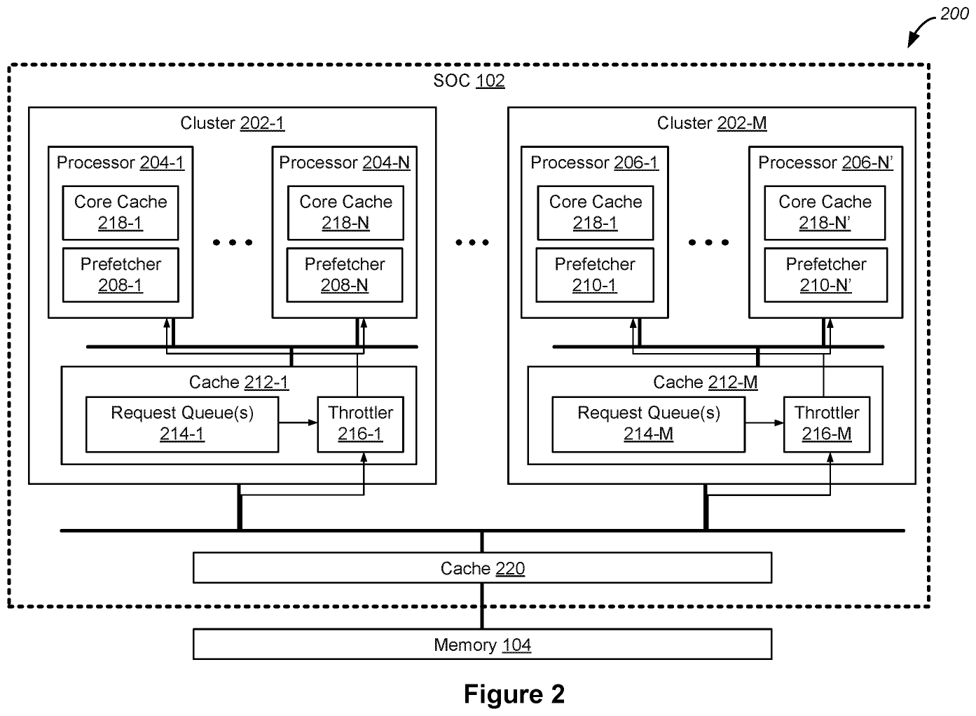

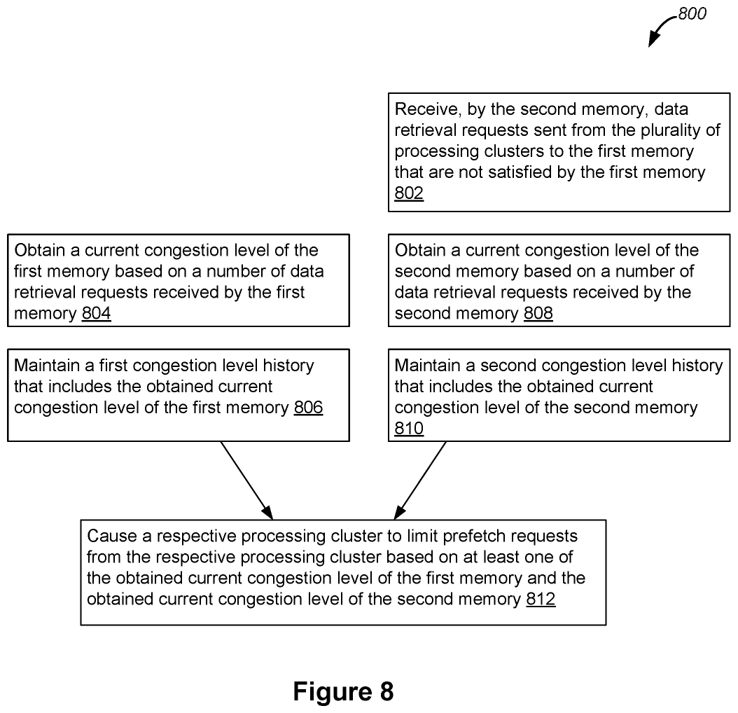

In some implementations, memory modules 104 (e.g., memory 104 in FIGS. 2-4, second memory in FIG. 8) include high-speed random access memory, such as DRAM, SRAM, DDR RAM or other random access solid state memory devices. In some implementations, memory modules 104 include non-volatile memory, such as one or more magnetic disk storage devices, optical disk storage devices, flash memory devices, or other non-volatile solid state storage devices. In some implementations, memory modules 104, or alternatively the non-volatile memory device(s) within memory modules 104, include a non-transitory computer readable storage medium. In some implementations, memory slots are reserved on system module 100 for receiving memory modules 104. Once inserted into the memory slots, memory modules 104 are integrated into system module 100.

In some implementations, system module 100 further includes one or more components selected from:
a memory controller 110 that controls communication between SoC 102 and memory components, including memory modules 104, in electronic device;
solid state drives (SSDs) 112 that apply integrated circuit assemblies to store data in the electronic device, and in many implementations, are based on NAND or NOR memory configurations;
a hard drive 114 that is a conventional data storage device used for storing and retrieving digital information based on electromechanical magnetic disks;
a power supply connector 116 that is electrically coupled to receive an external power supply;
power management integrated circuit (PMIC) 118 that modulates the received external power supply to other desired DC voltage levels, e.g., 5V, 3.3V or 1.8V, as required by various components or circuits (e.g., SoC 102) within electronic device;
a graphics module 120 that generates a feed of output images to one or more display devices according to their desirable image/video formats; and
a sound module 122 that facilitates the input and output of audio signals to and from the electronic device under control of computer programs.

It is noted that communication buses 140 also interconnect and control communications among various system components including components 110-122.

Further, one skilled in the art knows that other non-transitory computer readable storage media can be used, as new data storage technologies are developed for storing information in the non-transitory computer readable storage media in the memory modules 104 and in SSDs 112. These new non-transitory computer readable storage media include, but are not limited to, those manufactured from biological materials, nanowires, carbon nanotubes and individual molecules, even though the respective data storage technologies are currently under development and yet to be commercialized.

In some implementations, SoC 102 is implemented on an integrated circuit that integrates one or more microprocessors or central processing units, memory, input/output ports and secondary storage on a single substrate. SoC 102 is configured to receive one or more internal supply voltages provided by PMIC 118. In some implementations, both the SoC 102 and PMIC 118 are mounted on a main logic board, e.g., on two distinct areas of the main logic board, and electrically coupled to each other via conductive wires formed in the main logic board. As explained above, this arrangement introduces parasitic effects and electrical noise that could compromise performance of the SoC, e.g., cause a voltage drop at an internal voltage supply. Alternatively, in some implementations, SoC 102 and PMIC 118 are vertically arranged in an integrated semiconductor device, such that they are electrically coupled to each other via electrical connections that are not formed in the main logic board. Such vertical arrangement of SoC 102 and PMIC 118 can reduce a length of electrical connections between SoC 102 and PMIC 118 and avoid performance degradation caused by the conductive wires of the main logic board. In some implementations, vertical arrangement of SoC 102 and PMIC 118 is facilitated in part by integration of thin film inductors in a limited space between SoC 102 and PMIC 118.

FIG. 2 is a block diagram of an example electronic device 200 having one or more processing clusters 202 (e.g., first processing cluster 202-1, Mth processing cluster 202-M), in accordance with some implementations. Electronic device 200 further includes a cache 220 and a memory 104 in addition to processing clusters 202. Cache 220 is coupled to processing clusters 202 on SOC 102, which is further coupled to memory 104 that is external to SOC 102. Each processing cluster 202 includes one or more processors 204, a cluster cache 212, and a throttler 216 (also called prefetch throttling circuitry). Cluster cache 212 is coupled to one or more processors 204, and maintains one or more request queues 214 for one or more processors 204. Each processor 204 further includes a respective prefetcher 208 that is coupled to throttler 216 of respective processing cluster 202 to control cache prefetching associated with the respective processor 204. In some implementations, each processor 204 further includes a core cache 218 that is optionally split into an instruction cache and a data cache, and core cache 218 stores instructions and data that can be immediately executed by the respective processor 204.

In an example, first processing cluster 202-1 includes first processor 204-1, . . . , N-th processor 204-N, first cluster cache 212-1, and first throttler 216-1, where N is an integer greater than 1. First cluster cache 212-1 has one or more first request queues 214-1, and each first request queue includes a queue of demand requests and prefetch requests received from a subset of processors 204 of first processing cluster 202-1. In some embodiments, SOC 102 only includes a single processing cluster 202-1. Alternatively, in some embodiments, SOC 102 includes at least an additional processing cluster 202, e.g., M-th processing cluster 202-M. M-th processing cluster 202-M includes first processor 206-1, . . . , N′-th processor 206-N′, M-th cluster cache 212-M, and M-th throttler 216-M, where N′ is an integer greater than 1 and M-th cluster cache 212-M has one or more M-th request queues 214-M.

In some implementations, the one or more processing clusters 202 are configured to provide a central processing unit for an electronic device and are associated with a hierarchy of caches. For example, the hierarchy of caches includes three levels that are distinguished based on their distinct operational speeds and sizes. For the purposes of this application, a reference to “the speed” of a memory (including a cache memory) relates to the time required to write data to or read data from the memory (e.g., a faster memory has shorter write and/or read times than a slower memory), and a reference to “the size” of a memory relates to the storage capacity of the memory (e.g., a smaller memory provides less storage space than a larger memory). The core cache 218, cluster cache 212, and cache 220 correspond to a first level (L1) cache, a second level (L2) cache, and a third level (L3) cache, respectively. Each core cache 218 holds instructions and data to be executed directly by a respective processor 204, and has the fastest operational speed and smallest size among the three levels of memory. For each processing cluster 202, the cluster cache 212 is slower operationally than the core cache 218 and bigger in size, and holds data that is more likely to be accessed by processors 204 of respective processing cluster 202. The cache 220 is shared by the plurality of processing clusters 202, and bigger in size and slower in speed than each core cache 218 and cluster cache 212. In each processing cluster 202, respective throttler 216 monitors a system congestion level associated with memory accesses to cache 220 and memory 104 and a local cluster congestion level associated with cluster cache 212, and controls prefetches of instructions and data to core caches 218 and/or cluster cache 212 based on the system and/or cluster congestion levels. Each individual processor 204 further monitors a processor congestion level to control prefetches of instructions and data from respective cluster cache 212 into respective individual core cache 218.

In some implementations, first cluster cache 212-1 of first processing cluster 202-1 is coupled to a single processor 204-1 in the same processing cluster, and not to any other processors (e.g., 204-N). In some implementations, first cluster cache 212-1 of first processing cluster 202-1 is coupled to multiple processors 204-1 and 204-N in the same processing cluster. In some implementations, first cluster cache 212-1 of first processing cluster 202-1 is coupled to the one or more processors 204 in the same processing cluster 202-1, and not to processors in any cluster other than the first processing cluster 202-1 (e.g., processors 206 in cluster 202-M). In such cases, first cluster cache 212-1 of first processing cluster 202-1 is sometimes referred to as a second-level cache.

In each processing cluster 202, each request queue 214 optionally includes a queue of demand requests and prefetch requests received from a subset of processors 204 of respective processing cluster 202. Each data retrieval request received from respective processor 204 is distributed to one of request queues 214. In some implementations, a request queue 214 receives only requests received from a specific processor 204. In some implementations, a request queue 214 receives requests from more than one processor 204 in processing cluster 202, allowing a request load to be balanced among the plurality of request queues 214. Specifically, in some situations, a request queue 214 receives only one type of data retrieval requests (e.g., prefetch requests) from different processors 204 in the same processing cluster 202.

Each processing cluster 202 includes or is coupled to one or more prefetchers 208 in processors 204, and the prefetch requests are generated and processed by one or more prefetchers 208. In some implementations, each processor 204 in processing cluster 202 includes or is coupled to a respective prefetcher 208. In some implementations, two or more of processors 204 in processing cluster 202 share the same prefetcher 208.

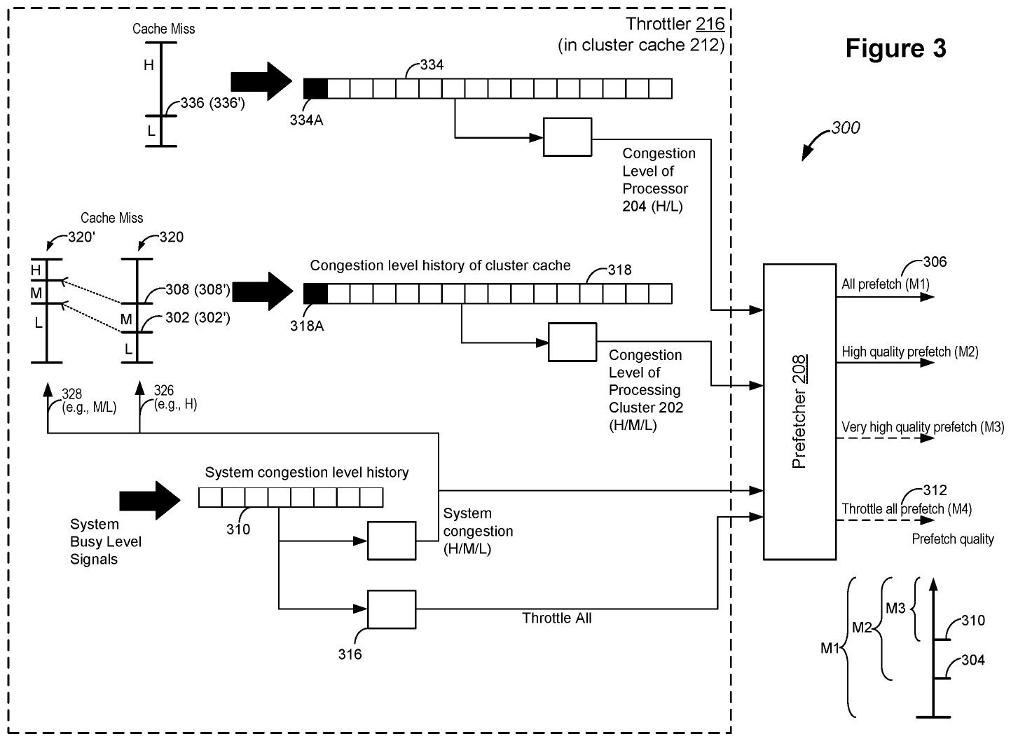

In each processing cluster 202, cluster cache 212 further includes a throttler 216 (also called prefetch throttling circuitry) that is coupled to an output of cluster cache 212, request queues 214 in cluster cache 212, and one or more processors 204 of processing cluster 202. On a cluster level, throttler 216 monitors a local cluster congestion level of corresponding processing cluster 202 based on signals received from request queues 214. Specifically, throttler 216 determines a congestion level of processing cluster 202 based on an extent to which the plurality of data retrieval requests sent from one or more processors 204 in processing cluster 202 to cluster cache 212 are not satisfied by cluster cache 212. In accordance with a determination that the congestion level of processing cluster 202 satisfies first congestion criteria that require that the congestion level of processing cluster 202 is above a first cluster congestion threshold, throttler 216 causes a first respective processor (e.g., processor 204-1) of one or more processors 204 to limit prefetch requests to cluster cache 212 to prefetch requests of at least a first threshold quality (i.e., to limit the prefetch requests to high quality prefetches). Specifically, in an example, throttler 216 transmits a signal or other information to processors 204 (e.g., prefetcher 208-1 in processors 204-1) to enable prefetch throttling, so that only prefetch requests of at least the first threshold quality are sent to cluster cache 212. This optionally corresponds to a second prefetch throttling mode M2, which is different from a first prefetch throttle mode and limits prefetching by processors 204 from cluster cache 212 to prefetch requests of at least the first threshold quality 304 in FIG. 3.

Alternatively, in accordance with a determination that the congestion level of processing cluster 202 does not satisfy the first congestion criteria (e.g., the congestion level of processing cluster 202 is below the first cluster congestion threshold), throttler 216 forgoes causing the one or more processors to limit prefetch requests to cluster cache 212 to prefetch requests of at least the first threshold quality. For example, throttler 216 forgoes causing processors 204 to limit prefetch requests to cluster cache 212 entirely, such that no prefetch requests, of any quality, are limited. This optionally corresponds to the first prefetch throttling mode M1, in which prefetching of processors 204 from cluster cache 212 is not limited by throttler 216 as explained with reference to FIG. 3.

In some implementations, a congestion level below the first cluster congestion threshold indicates a low degree of congestion in cluster cache 212, and a congestion level above the first cluster congestion threshold indicates one or more higher degrees of congestion. If the one or more higher degrees of congestion correspond to a single high degree of congestion, the congestion level above the first cluster congestion threshold indicates this high degree of congestion. In contrast, if the one or more higher degrees of congestion correspond to a set of degrees of congestion (e.g., medium, high, and very high), the congestion level above the first cluster congestion threshold is associated with any degree in the set of degrees of congestion. More details on cluster congestion thresholds are discussed below with reference to FIG. 3.

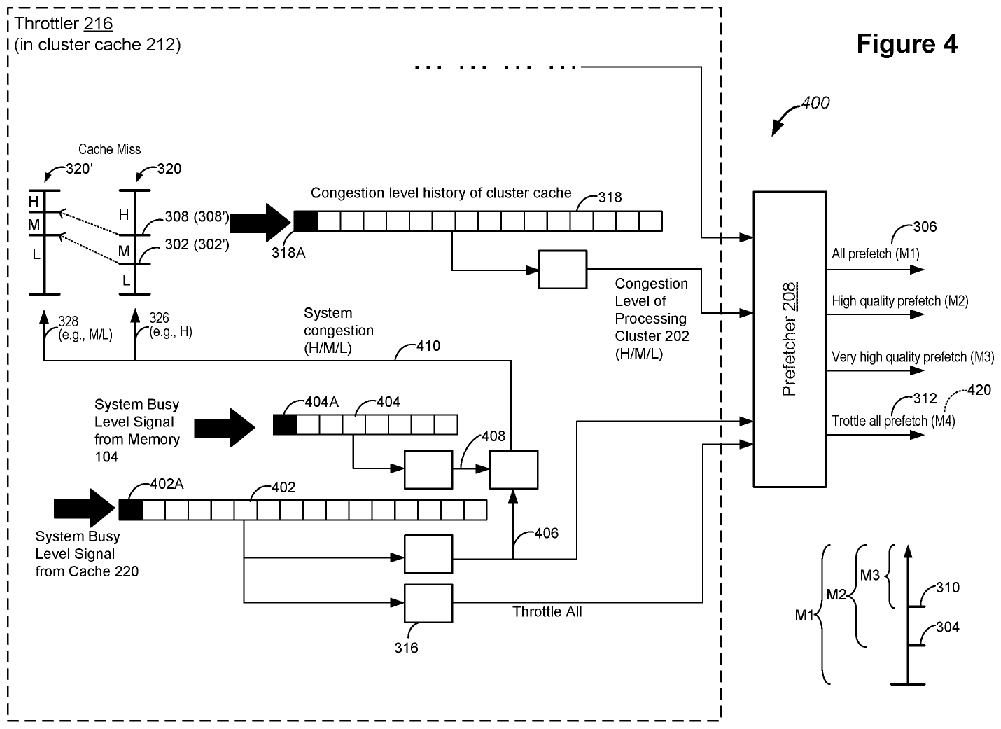

Further, in some implementations, on a system level, throttler 216 monitors a system congestion level of a memory system coupled to processing cluster 202 based on a system busy level signal received from the output of cluster cache 212. The system busy level signal includes information of outstanding in-flight requests that are received and not satisfied by cache 220 or memory 104. Specifically, throttler 216 obtains a current congestion level of cache 220 based on a number of outstanding in-flight requests received by cache 220, and maintains a first congestion level history (e.g., a history 402 in FIG. 4) that includes the obtained current congestion level of cache 220. Throttler 216 also obtains a current congestion level of memory 104 based on a number of outstanding in-flight requests received by memory 104, and maintains a second congestion level history (e.g., a history 404 in FIG. 4) that includes the current congestion level of memory 104. In some situations, data retrieval requests not satisfied by cache 220 are further sent to memory 104, and the number of outstanding in-flight requests received by memory 104 is therefore determined based on an extent to which data retrieval requests sent to cache 220 are not satisfied by cache 220. Throttler 216 causes processing cluster 202 to limit prefetch requests from processing cluster 202 based on at least one of the current congestion level of cache 220 and the current congestion level of memory 104. In some implementations, the prefetch requests from processing cluster 202 are limited based on the first congestion level history and/or the second congestion level history. In some implementations, throttler 216 is configured to determine the first congestion level of cache 220 (which is a composite congestion level) based on the first congestion level history or determine a second congestion level of memory 104 (which is a composite congestion level) based on the second congestion level history. The prefetch requests from processing cluster 202 may be limited based on the first congestion level and/or the second congestion level. In some implementations, a history of the first congestion level and/or a history of the second congestion level are maintained by throttler 216 itself.

FIG. 3 illustrates an example method 300 of determining a congestion level for controlling cache prefetching in a processing cluster 202 (e.g., first processing cluster 202-1 of FIG. 2), in accordance with some implementations. In this processing cluster 202, throttler 216 of cluster cache 212 determines a congestion level of processing cluster 202 based on an extent to which data retrieval requests sent from processors 204 in processing cluster 202 to cluster cache 212 are not satisfied by cluster cache 212, and controls prefetch requests from a prefetcher 208 associated with a first respective processor 204-1 in processing cluster 202. Specifically, in accordance with a determination that the congestion level of processing cluster 202 satisfies first congestion criteria that require that the congestion level of processing cluster 202 is above a first cluster congestion threshold 302, throttler 216 causes first respective processor 204-1 of the one or more processors 204 to limit prefetch requests to cluster cache 212 to prefetch requests of at least a first threshold quality 304. Conversely, in accordance with a determination that the congestion level of processing cluster 202 does not satisfy the first congestion criteria, throttler 216 forgoes causing the one or more processors 204 (including the first respective processor 204-1) to limit (306) prefetch requests to cluster cache 212 to prefetch requests of at least the first threshold quality 304. Stated another way, when the congestion level of processing cluster 202 is below first cluster congestion threshold 302, throttler 216 does not limit prefetch requests for processing cluster 202 in a first prefetch throttling mode M1; and when the congestion level of processing cluster 202 is beyond cluster congestion threshold 302, throttler 216 causes first respective processor 204-1 to limit prefetch requests to prefetch requests of at least the first threshold quality 304, i.e., to limit prefetch requests to high quality prefetches in a second prefetch throttling mode M2.

In some implementations, in accordance with a determination that the congestion level of processing cluster 202 satisfies second congestion criteria, different from the first congestion criteria, that require that the congestion level of processing cluster 202 is above a second cluster congestion threshold 308 that is above the first cluster congestion threshold 302, throttler 216 causes the first respective processor 204-1 to limit prefetch requests to prefetch requests of at least a second threshold quality 310 that is higher than the first threshold quality 304. In some implementations, if the congestion level of processing cluster 202 is above second cluster congestion threshold 308 (e.g., indicating high congestion as opposed to low or medium congestion), throttler 216 causes at least a respective processor 204 (e.g., first respective processor 204-1) of processing cluster 202 to operate in a third prefetch throttling mode M3 in which prefetching is limited to prefetches of at least the second threshold quality 310 (e.g., allowing only prefetches that are at least very high quality prefetches). In contrast, in first prefetch throttling mode M1, prefetching is not limited, and in a second prefetch throttling mode M2, prefetching is limited to prefetches having a quality between the first and second threshold qualities 304 and 310 (e.g., allowing prefetches that are at least high quality prefetches).

In some implementations, in accordance with a determination that the congestion level of processing cluster 202 satisfies third congestion criteria, throttler 216 causes the first respective processor 204-1 to forgo transmitting (312) prefetch requests to the cache entirely, e.g., without regard to a quality of a requested prefetch. Stated another way, if the third congestion criteria are satisfied, throttler 216 causes at least a respective processor 204 of processing cluster 202 to operate in a fourth prefetch throttling mode M4 (also called a throttle all mode). In some implementations, in the fourth prefetch throttling mode M4, all prefetching is disabled, i.e., no prefetching is implemented for cluster cache 212 or corresponding core caches 218.

Additionally, in some implementations, the third congestion criteria include (1) a first requirement that the congestion level of processing cluster 202 is above the cluster congestion threshold 308 and (2) a second requirement that a system congestion level history 310 of electronic device 200 satisfies a first system congestion condition 316 (e.g., 75% of a system congestion level history is high). The system congestion level history 310 is monitored by throttler 216 based on a system busy level signal received from cache 220, thereby indicating a congestion level of cache 220. For example, the system congestion level history 310 is filled with “H” or “L” based on a plurality of sampled values of the system busy level signal. The first system congestion condition 316 requires that 75% or more of the system congestion level history 310 is filled with “H” to enable the fourth prefetch throttling mode M4 (i.e., the throttle all mode). Conversely, in some embodiments, throttler 216 disables and resets the fourth prefetch throttling mode M4 when a second system congestion condition is satisfied, e.g., when 25% or less of the system congestion level history 310 is filled with “H”.

In some implementations, the extent to which the plurality of data retrieval requests, sent from processors 204 in processing cluster 202 to cluster cache 212, are not satisfied by cluster cache 212 is represented by one or more historical congestion levels for processing cluster 202. The one or more historical congestion levels are maintained in a congestion level history 318 for processing cluster 202. The congestion level of processing cluster 202 is determined based on a portion or all of the one or more historical congestion levels in the congestion level history 318. In an example, each historical congestion level in congestion level history 318 corresponds to a distinct respective period of time and represents the extent to which data retrieval requests were not satisfied by the cache during the respective period of time. The historical congestion level of processing cluster 202 may have been periodically sampled and stored in the congestion level history 318. In some implementations, a respective historical congestion level (or each respective historical congestion level) has a value selected from a predetermined set of congestion level values. For example, where two congestion levels are used, a respective historical congestion level has a first congestion level value (e.g., “low”) or a second congestion level value (e.g., “high”), e.g., defined based on first cluster congestion threshold 302. In another example, where three congestion levels are used, a respective historical congestion level has a first congestion level value (e.g., “low”), or a second congestion level value (e.g., “medium”), or a third congestion level value (e.g., “high”), e.g., defined based on cluster congestion thresholds 302 and 308. One of ordinary skill in the art will recognize that any number of congestion levels may be used, and any number of distinct congestion level values used accordingly.

In some implementations, a current cluster congestion level 318A of processing cluster 202 is determined based on a comparison with congestion level thresholds 302 and 308, and stored into congestion level history 318, e.g., in place of the oldest historic congestion level stored therein. The congestion level of processing cluster 202 is determined based on a portion or all of the congestion level history 318 including the current cluster congestion level 318A of processing cluster 202. For example, in accordance with a determination that the current cluster congestion level (e.g., equal to “high”) 318A is greater than the congestion level of processing cluster 202 (e.g., equal to “medium”), the congestion level of the processing cluster 202 is increased by one level or to the current cluster congestion level 318A. In accordance with a determination that all existing historic congestion levels (e.g., equal to “medium” or “low”) in history 318 are lower than the congestion level of the processing cluster 202 (e.g., equal to “high”), the congestion level of the processing level 202 is reduced by one level. Otherwise, the congestion level of the processing level 202 does not change. The current cluster congestion level 318 is the most recent cluster congestion level measured based on cluster congestion thresholds 302 and 308. Alternatively, in some embodiments, the first and second cluster congestion thresholds 302 and 308 are applied in conjunction with a historical congestion threshold (e.g., 10% of congestion level history 318). For example, the congestion level of processing cluster 202 satisfies the first congestion criteria if a portion (e.g., 75%) of the congestion level history 318 is above the first cluster congestion threshold 302 (i.e., has a value of “medium” or “high”) and exceeds the historical congestion threshold (e.g., 10%).

It is noted that in some implementations, the congestion level of processing cluster 202 is determined based on an extent to which the plurality of data retrieval requests sent from the one or more processors 204 in processing cluster 202 to cluster cache 212 are not satisfied by the cache 212, without regard to which of the one or more processors 204 sent the plurality of data retrieval requests. That said, the congestion level of processing cluster 202 is determined without regard to an extent to which data retrieval request(s) from a specific processor of the one or more processors 204 are not satisfied by cluster cache 212.

In some implementations, determining the congestion level of processing cluster 202 includes comparing the number of data retrieval requests, sent from the one or more processors 204 in processing cluster 202 to cluster cache 212, that are not satisfied by cluster cache 212 (e.g., also called cache misses) to one or more cache miss thresholds. Each cluster congestion threshold 302 and 308 includes a respective cache miss threshold 302′ or 308′. In some implementations, the number of cache misses by processing cluster 202 is compared to the one or more cache miss thresholds 302′ or 308′ to determine a cache miss value (e.g., low, medium, high, etc.), which is taken into account when determining the congestion level of processing cluster 202. For example, if the number of cache misses by processing cluster 202 is below a first cache miss threshold 302′, a first cache miss value (e.g., a low value) is taken into account when determining the congestion level of processing cluster 202. In another example, if the number of cache misses by processing cluster 202 is above the first cache miss threshold 302′, a second cache miss value (e.g., a medium or high value) is taken into account when determining the congestion level of processing cluster 202. In yet another example, if the number of cache misses by processing cluster 202 is above a second cache miss threshold 308′, a third cache miss value (e.g., a high value) is taken into account when determining the congestion level of processing cluster 202. In some implementations, the cache miss value is taken into account in the context of one or more historical congestion levels in a congestion level history 318 for processing cluster 202. In an example, the cache miss value defines the historical congestion levels stored in the congestion level history 318 for processing cluster 202.

Further, in some implementations, the one or more cache miss thresholds (i.e., cache miss thresholds 302′ and 308′) are determined based on a system congestion level (e.g., 410 in FIG. 4) of electronic device 200. In some implementations, a first set 320 of one or more cache miss thresholds is used in accordance with a determination that the system congestion level is a first congestion value 326, and a different second set 320′ of one or more cache miss thresholds is used in accordance with a determination that the system congestion level is a different second congestion value 328. If needed, additional different sets of one or more cache miss thresholds may be used for any number of different system congestion values. In some implementations, second congestion value 328 is lower than first congestion value 326, and each cache miss threshold 302′ or 308′ is adjusted to a higher value in association with the second congestion value 328, because where system congestion is low, higher amounts of cluster congestion may be tolerated. For example, first cache miss threshold 302′ is adjusted from 30% to 50%, when the system congestion level drops from first congestion value 326 to second congestion value 328. On the other hand, the higher the system congestion level, the lower the one or more cache miss thresholds of the set 320, because where system congestion is already high, lower amounts of cluster congestion (e.g., of processing cluster 202) may warrant throttling than where system congestion is low.

In some implementations, the plurality of data retrieval requests include all data retrieval requests sent from the one or more processors 204 to cluster cache 212 within a predefined period of time, i.e., include all demand requests and all prefetch requests.

In some implementations, throttler 216 determines that a congestion level of a respective processor 204-1 or 204-N is below a processor congestion threshold 336 that is different from the congestion threshold 302 or 308 used for cluster cache 212, regardless of the congestion level of processing cluster 202, and forgoes limiting prefetch requests from respective processor 204-1 or 204-N to cluster cache 212. That said, in these embodiments, the prefetch requests from respective processor 204-1 or 204-N are not limited based on the cluster congestion level and system congestion level, when the congestion level of the respective processor is below the processor congestion threshold 336 (e.g., equal to “L”). Conversely, if the congestion level of respective processor 204-1 or 204-N is beyond processor congestion threshold 336 (e.g., equal to “H”), the prefetch requests from respective processor 204-1 or 204-N to cluster cache 212 are limited or throttled based on the congestion levels of the processing cluster and system. The congestion level of respective processor 204-1 or 204-N is determined based on an extent to which data retrieval requests sent from the respective processor 204-1 or 204-N to cluster cache 212 are not satisfied by cluster cache 212, e.g., independently of whether data retrieval requests sent to cluster cache 212 from any processors other than the respective processor 204-1 or 204-N are satisfied by cluster cache 212.

Stated another way, in some implementations, the first congestion criteria further require that the congestion level of a respective processor 204 be above processor congestion threshold 336 in order for throttler 216 to limit prefetch requests from the respective processor. In some implementations, the determination whether to limit prefetch requests from a respective processor based on whether the congestion level of the respective processor is above the processor congestion threshold 336 takes priority over other determinations regarding whether to limit prefetch requests (e.g., with respect to the first congestion criteria, second congestion criteria, and/or third congestion criteria concerning the congestion level of processing cluster 202).

In some implementations, throttler 216 maintains a processor congestion level history 334 to store historical congestion levels of each processor 204. The prefetch requests from the respective processor is limited based on the congestion level of processor 204 that is determined based on at least a portion of congestion level history 334 of this processor 204. A current congestion level of processor 204 is recorded and compared with processor congestion threshold 336, and one of a plurality of values (e.g., “L” and “H”) is determined based on a comparison result and stored as a current congestion level 334A in congestion level history 334 of this processor 204 (e.g., in place of the oldest cache miss level in history 334). In accordance with a determination that the current congestion level 334A of processor 204 indicates a higher congestion level than the congestion level of processor 202, the congestion level of processor 202 is increased by one level or to the current congestion level 334A. In accordance with a determination that the entire congestion level history 334 of processor 204 is lower than the congestion level of processor 202, the congestion level of processor 202 is reduced by one level or to the lower congestion level, e.g., from “H” to “L”.

Further, in some implementations, processor congestion threshold 336 includes a processor cache miss threshold 336′. Determining the congestion level of processor 204 includes comparing a number of data retrieval requests, sent from respective processor 204 to cluster cache 212, that are not satisfied by cluster cache 212 (i.e., cache misses) to a processor cache miss threshold 336. For example, if the number of cache misses for processor 204 is below cache miss threshold 336′, a first cache miss value (e.g., a low value) is taken into account when determining the congestion level of processor 204; if the number of cache misses for processor 204 is above cache miss threshold 336′, a second cache miss value (e.g., a medium or high value) is taken into account when determining the congestion level of processor 204. Specially, in some implementations, a current cache miss is determined for a current number of data retrieval requests that are not satisfied by cluster cache 212 during a sample duration of time. The current cache miss is compared with cache miss threshold 336, and one of a plurality of cache miss values (e.g., “L” and “H”) is determined based on a comparison result and stored as a current cache miss level 334A in congestion level history 334 of this processor 204 (e.g., in place of the oldest cache miss level in history 334). In accordance with a determination that the current cache miss level 334A of processor 204 indicates a higher congestion level than the congestion level of processor 202, the congestion level of processor 202 is increased by one level or to the current cache miss level 334A. In accordance with a determination that congestion level history 334 of processor 204 indicates a lower congestion level than the congestion level of processor 202 (e.g., all cache miss levels in the congestion level history 334 are lower than the congestion level of processor 202), the congestion level of processor 202 is reduced by one level or to the lower congestion level, e.g., from “H” to “L”.

In some implementations, the electronic device 200 includes a second processing cluster 202-M having one or more second processors 206 different from the one or more processors 204 of processing cluster 202-1. Throttler 216-1 limits prefetch requests by processing cluster 202-1, independently of whether prefetch requests from one or more second processors 206 of second processing cluster 202-M are limited. In some implementations, prefetching by second processing cluster 202-M is controlled in accordance with any of the methods for controlling prefetching described herein with respect to processing cluster 202-1. In some implementations, prefetching by second processing cluster 202-M may indirectly affect prefetching by processing cluster 202-1 by indirectly affecting system congestion; however, prefetching or prefetch throttling of second processing cluster 202-M is not directly taken into account in determining whether to limit prefetching by processing cluster 202-1.

FIG. 4 illustrates an example method 400 of determining a system congestion level for controlling cache prefetching in an individual processing cluster 202 (e.g., first processing cluster 202-1), in accordance with some implementations. A data retrieval request of a processor 204 of processing cluster 202 is sent to cluster cache 212. If this data retrieval request is not satisfied by cluster cache 212, it continues to be sent to cache 220 that is shared by processing cluster 202 with one or more other processing clusters. If the data retrieval request is not satisfied by cache 220, it is further sent to memory 104. The system congestion level indicates how many data retrieval requests from processors 204 are sent to cache 220 or memory 104. Specifically, a first congestion level history 402 and a second congestion level history 404 are maintained by throttler 216. A current congestion level of cache 220 is obtained based on a number of outstanding in-flight requests received by cache 220, and stored in the first congestion level history 402. A current congestion level of memory 104 is obtained based on a number of outstanding in-flight requests received by memory 104, and stored in second congestion level history 404. In some implementations, information of the outstanding in-flight requests that are not satisfied by cache 220 or memory 104 are determined based on system busy level signals that are received from cache 220 and memory 104 in response to the data retrieval requests sent to cache 220 and memory 104, respectively.

The current congestion levels of cache 220 and memory 104 are monitored with respective sampling rates that are optionally equal to or different from each other. First and second congestion level histories 402 and 404 can store up to respective limited numbers of historical congestion levels, and the respective limited numbers are optionally equal to or different from each other. In an example, the first and second congestion level histories 402 and 404 track a first integer number of historical congestion levels of cache 220 and a second integer number of historical congestion levels of memory 104. The first and second integer numbers are optionally equal to or distinct from each other.

In some implementations, throttler 216 is configured to cause processing cluster 202 to limit prefetch requests from processing cluster 202 in accordance with a highest throttling level 420 based on first congestion level history 402 of cache 220 including the obtained current congestion level 402A of cache 220. In some situations, highest throttling level 420 is determined without regard to the obtained current congestion level of memory 104. In some implementations, whether prefetch requests from processing cluster 202 are limited in accordance with highest throttling level 420 is based on the obtained current congestion level of cache 220, on first congestion level history 402 of cache 220, and/or on a first congestion level of cache 220 that is determined based on at least a portion of first congestion level history 402 of cache 220. For example, highest throttling level 420 may be determined with reference to a first system congestion condition 316 (e.g., at least a predefined percentage of first congestion level history 402 is equal to “H”). In some implementations, congestion of cache 220, but not congestion of memory 104, determines whether prefetch requests from processing cluster 202 are limited in accordance with highest throttling level 420. Additionally, in some implementations, throttler 216 is configured to cause processing cluster 202 to limit prefetch requests in accordance with highest throttling level 420 based on the congestion levels of both processing cluster 202 and cache 220. For example, highest throttling level 420 is applied to limit prefetching, when the congestion level of processing cluster 202 is above the cluster congestion threshold 308 and first congestion level history 402 of cache 220 satisfies first system congestion condition 316. In some implementations, highest throttling level 420 corresponds to a throttle all mode M4 in which no prefetching is permitted (312).

Further, in some implementations, throttler 216 is configured to cause processing cluster 202 to limit prefetch requests from processing cluster 202 in accordance with highest throttling level 420 based on first congestion level history 402 of cache 220, e.g., based on a subset of first congestion level history 402 and/or second congestion level history 404. The subset of first congestion level history 402 includes less than all or all congestion levels stored history 402. In an example, throttler 216 causes processing cluster 202 to limit prefetch requests from processing cluster 202 based on one or more most-recently determined and recorded congestion levels of cache 220. In some implementations, the subset of first congestion level history 402 has the same number of recorded historical congestion levels (e.g., the same number of samples or entries) as second congestion level history 404.

In some implementations, throttler 216 is configured to cause processing cluster 202 to limit prefetch requests from processing cluster 202 in accordance with highest throttling level 420, e.g., to activate highest throttling level 420, based on a determination that first congestion level history 402 includes more than a first threshold number of determined congestion levels indicating a respective congestion level of cache 220 (e.g., a high congestion level “H” that is above a system congestion threshold). For example, highest throttling level 420 is activated if first congestion level history 402 (or the subset of first congestion level history 402) includes greater than a first threshold number (or alternatively, first threshold percentage) of instances where the high congestion level (e.g., “H”) was recorded for cache 220.

In some implementations, throttler 216 is configured to cause processing cluster 202 to forgo limiting prefetch requests from processing cluster 202 in accordance with highest throttling level 420, e.g., to deactivate highest throttling level 420, based on a determination that first congestion level history 402 includes less than a second threshold number of determined congestion levels indicating the respective congestion level of cache 220 (e.g., the high congestion level “H” that is above the system congestion threshold). For example, highest throttling level 420 is deactivated if first congestion level history 402 (or the subset of first congestion level history 402) includes less than a second threshold number (or alternatively, second threshold percentage) of instances where a high congestion level (e.g., “H”) was recorded for cache 220. In some implementations, the first threshold number is the same as the second threshold number (or alternatively, the first threshold percentage is the same as the second threshold percentage). In some implementations, the first threshold number is different from (e.g., greater than) the second threshold number (or alternatively, the first threshold percentage is different from the second threshold percentage). In an example, both the first and second threshold percentages are 50%. In another example, the first threshold percentage is 75%, and the second threshold percentage is 25%.

In some implementations, limiting prefetch requests from processing cluster 202 in accordance with highest throttling level 420 includes limiting all prefetch requests from processing cluster 202, e.g., in a throttle all mode M4. In accordance with highest throttling level 420, no prefetch requests from processing cluster 202 are permitted.

In some implementations, throttler 216 determines a first congestion level of cache 220 and a second congestion level of memory 104. In accordance with a determination that the obtained current congestion level 402A of cache 220 indicates a higher congestion level than the first congestion level, throttler 216 increases the first congestion level, e.g., to a next-higher level in a set of possible congestion levels. Conversely, in accordance with a determination that first congestion level history 402 indicates a lower congestion level than the first congestion level (e.g., the entire first congestion level history 402 is lower than the first congestion level), throttler 216 decreases the first congestion level. For example, in accordance with a determination that no entry in first congestion level history 402 indicates a congestion level higher than the current value of the first congestion level, throttler 216 decreases the first congestion level, e.g., to a next-lower level in the set of possible congestion levels. Similarly, in some implementations, in accordance with a determination that the obtained current congestion level 404A of memory 104 indicates a higher congestion level than (e.g., a current value of) the second congestion level, throttler 216 increases the second congestion level, e.g., to a next-higher level in the set of possible congestion levels. In accordance with a determination that second congestion level history 404 indicates a lower congestion level than the second congestion level (e.g., the entire second congestion level history 404 is lower than the second congestion level), throttler 216 decreases the second congestion level. For example, in some implementations, in accordance with a determination that no entry in second congestion level history 404 indicates a congestion level higher than the current value of the second congestion level, throttler 216 decreases the second congestion level, e.g., to a next-lower level in the set of possible congestion levels. As such, throttler 216 causes processing cluster 202 to limit prefetch requests from processing cluster 202 based on the first congestion level and the second congestion level, and the first congestion level and the second congestion level are taken into account in determining whether to limit prefetch requests in accordance with a respective throttling level that is below a highest throttling level.

In some implementations, first system congestion level 406 is determined based on the obtained current congestion level 402A of cache 220, on first congestion level history 402 of cache 220, and/or on the first congestion level of cache 220 that is determined based on at least a portion of first congestion level history 402 of cache 220. A second system congestion level 408 is determined based on the obtained current congestion level 404A of memory 104, on second congestion level history 404 of memory 104, and/or on a second congestion level of memory 104 that is determined based on at least a portion of second congestion level history 404 of memory 104. Congestion levels 406 and 408 are combined to generate a combined system congestion level 410 having two or more congestion values, such as first congestion value 326 and second congestion value 328, which are applied to determine different cache miss thresholds (i.e., cache miss thresholds 302′ and 308′). In some embodiments, the combined system congestion level 410 is equal to a greater one of congestion level 406 of cache 220 and congestion level 408 of memory 104. For example, if congestion level 406 is “L” and congestion level 408 is “H”, the combined system congestion level 410 is “H”. If congestion level 406 is “H” and congestion level 408 is “L”, the combined system congestion level 410 is still “H”.

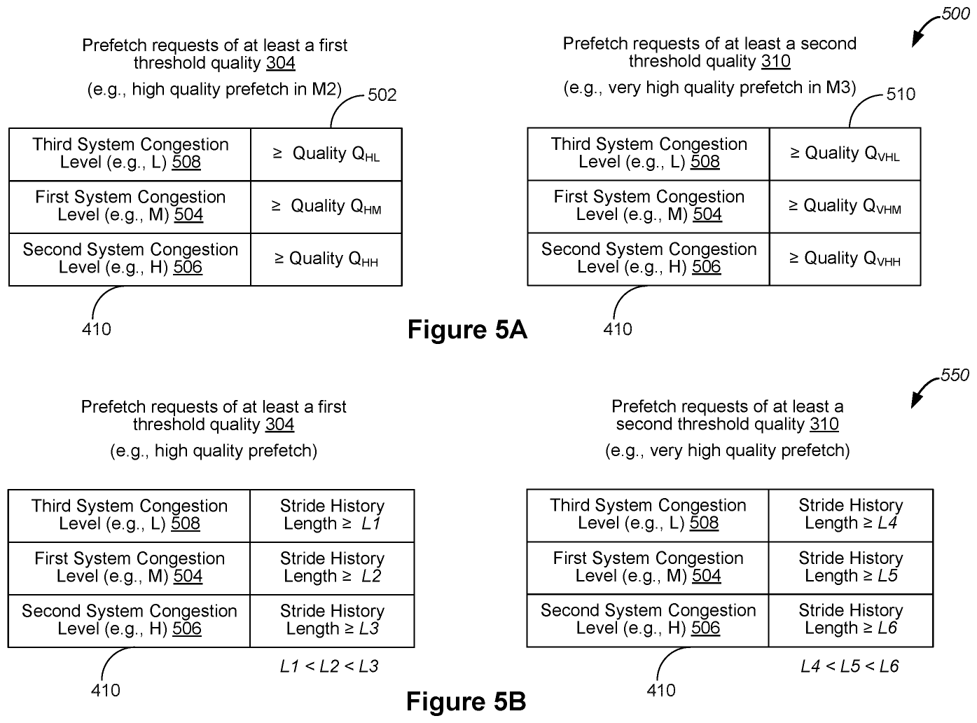

FIG. 5A illustrates two tables 500 showing definitions of quality thresholds associated with prefetch qualities of prefetches that are limited under different system congestion levels, in accordance with some implementations. As explained above, in accordance with a determination that a congestion level of processing cluster 202 satisfies first congestion criteria that require that the congestion level of the first processing cluster is above a first cluster congestion threshold 302, throttler 216 causes a first respective processor 204 to limit prefetch requests to cluster cache 212 to prefetch requests of at least a first threshold quality 304. For example, first threshold quality 304 is selected from a set of quality thresholds 502 based on a system congestion level (e.g., a combined system congestion level 410 of a first congestion level 406 of cache 220 and a second congestion level 408 of memory 104 in FIG. 4), respectively. In some implementations, the lower the system congestion level 410 is, the lower threshold quality 304 is for permitted prefetch requests, because cache 220 and memory 104 has a greater capacity for handling prefetches during periods of lower system congestion. Conversely, the higher the system congestion level 410 is, the higher threshold quality 304 is for permitted prefetch requests, because cache 220 and memory 104 has a reduced capacity for handling prefetches during periods of higher system congestion. That said, a first system congestion level 504 is lower than a second system congestion level 506 and higher than a third system congestion level 508, and a first value (Q_{HM}) of first threshold quality 304 corresponding to first system congestion level 504 is less than a second value (Q_{HH}) of first threshold quality 304 corresponding to second system congestion level 506 and greater than a third value (Q_{HL}) of first threshold quality 304 corresponding to third system congestion level 508.

In some implementations, a threshold quality for prefetch requests is dependent on a local cluster congestion level of cluster cache 212, in addition to the system congestion level 410 of cache 220 and/or memory 104. In accordance with a determination that the congestion level of processing cluster 202 satisfies second congestion criteria, different from the first congestion criteria, that require that the congestion level of processing cluster 202 is above a second cluster congestion threshold 308 that is above the first cluster congestion threshold 302, throttler 216 causes the first respective processor 204 to limit prefetch requests to cluster cache 212 to prefetch requests of at least a second threshold quality 310 that is higher than the first threshold quality 304. In some implementations, a first threshold quality 304 (e.g., high-quality prefetch) is selected from a first set of quality thresholds 502 based on the system congestion level 410, and a second threshold quality 310 (e.g., very high-quality prefetch) is selected from a second set of quality thresholds 510 based on the system congestion level 410. In the second set of quality thresholds 510, first system congestion level 504 is higher than third system congestion level 508 and lower than second system congestion level 506, and a first value (Q_{VHM}) of second threshold quality 310 corresponding to first system congestion level 504 is less than a second value (Q_{VHH}) of second threshold quality 310 corresponding to second system congestion level 506 and greater than a third value (Q_{VHL}) of second threshold quality 310 corresponding to third system congestion level 508. For the same system congestion level, e.g., 504, first value (Q_{VHM}) of second threshold quality 310 is also higher than first value (Q_{HM}) of first threshold quality 304 because the local cluster congestion level of cluster cache 212 is higher in association with second threshold quality 310.

FIG. 5B illustrates two tables 550 showing quality thresholds associated with stride history lengths of prefetches that are limited under different system congestion levels 410, in accordance with some implementations. In an example, prefetcher 208 implements stride prefetching including cache or memory accesses with a constant stride. A stride is determined based on a stride history length associated with a number of consecutive times the stride is verified during previous processor operation. The stride history length indicates a confidence level on accuracy of prediction of the corresponding cache or memory accesses. As such, for first set of threshold quality 304, the threshold stride history lengths are set to L1, L2 and L3 for three distinct system congestion levels 504-508 (e.g., “L”, “M” and “H”), where L1, L2, and L3 are integer numbers and L2 is greater than L1 and less than L3. For second set of quality thresholds 308, the threshold stride history lengths are set to L4, L5 and L6 for three distinct system congestion levels 504-508 (e.g., “L”, “M” and “H”), where L4, L5, and L6 are integer numbers and L5 is greater than L4 and less than L6.

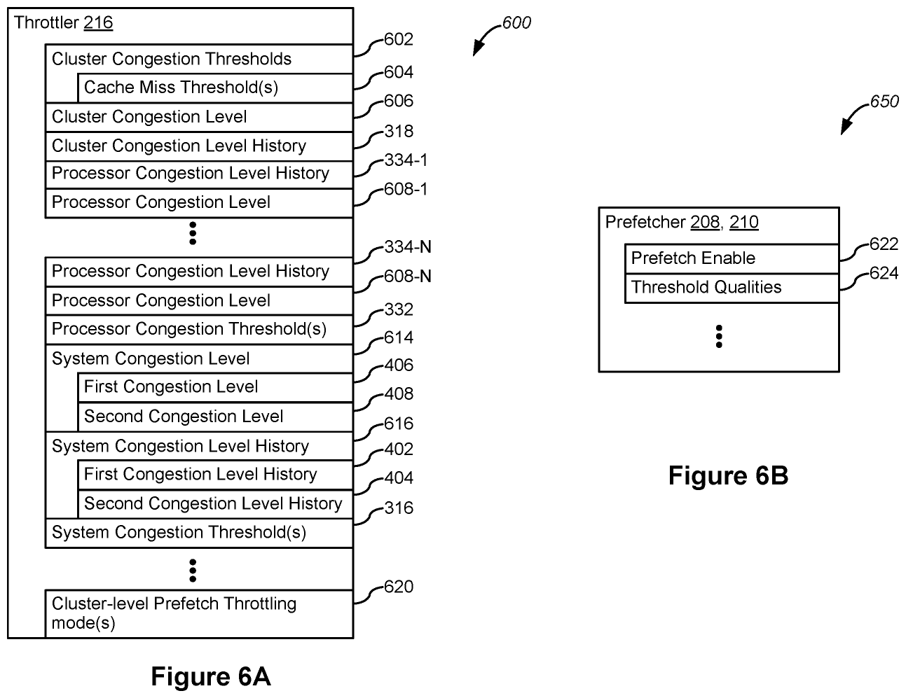

FIGS. 6A and 6B are data structures 600 and 650 of data stored for a throttler 216 (also called prefetch throttling circuitry) and prefetcher 208, in accordance with some implementations, respectively. Each processing cluster 202 includes a respective throttler 216 that involves data in data structure 600, and each processor 204 in the respective processing cluster 202 further includes prefetcher 208 that involves data in data structure 650. In each processing cluster 202, respective throttler 216 is associated with a subset or all of the following data:
One or more cluster congestion thresholds 602 for determining a congestion level of processing cluster 202, e.g., cluster congestion thresholds 302 and 308, where the one or more cluster congestion thresholds 602 include one or more cache miss thresholds 604 for determining a congestion level of each processing cluster 202 based on the number of data retrieval requests that are not satisfied by cluster cache 212, e.g., cache miss thresholds 302′ and 308′;
Cluster congestion level 606 that is determined based on an extent to which data retrieval requests sent from one or more processors in processing cluster 202 to cluster cache 212 are not satisfied by cluster cache 212;
Cluster congestion level history 318 for storing historical congestion levels of processing cluster 202;
Processor congestion levels 608 that are determined based on an extent to which data retrieval requests sent by individual processors 204 of processing cluster 202 are not satisfied by cluster cache 212, where each processor 204 has a respective processor congestion level 608, e.g., a first processor congestion level 608-1 for a first processor 204-1 and an N-th processor congestion level 608-N for an N-th processor 204-N;
Processor congestion level histories 334 for storing historical congestion levels of processors 204 in respective processing cluster 202, including a first congestion history 334-1 for first processor 204-1 and a second congestion history 334-N for N-th processor 204-N;
One or more processor congestion thresholds 336 for determining a congestion level of processors of processing cluster 202;
System congestion levels 614 including one or more of: current congestion levels of cache 220 and memory 104, a congestion level 406 of cache 220, a congestion level 408 of memory 104, and a combined system congestion level 410, where these congestion levels are determined based on numbers of data retrieval requests sent from processing cluster 202 to cache 220 and memory 104, both of which are external to processing cluster 202, respectively;
System congestion history 616 including a first congestion level history 402 and a second congestion level history 404 for storing historical congestion levels of cache 220 and memory 104, respectively;
One or more system congestion conditions (e.g., first system congestion condition 316) for determining whether system congestion levels 614 of cache 220 and memory 104 triggers the throttle all mode M4; and
One or more cluster prefetch throttling modes 620 for limiting prefetch requests to cluster cache 212, cache 220 or memory 104 to prefetch requests of at least a threshold quality or disabling all prefetch requests, including a throttle all mode (M4) in which throttler 216 forgoes transmitting any prefetch requests to cluster cache 212, cache 220 and/or memory 104.

Additionally, in each processor 204, respective prefetcher 208 is associated with a subset of or all of the following data:
Prefetch enable data 622 for indicating to which extent prefetch requests from the respective processor 204 to cluster cache 212, cache 220 or memory 104 are limited, e.g., that the prefetch questions are limited to prefetch requests of at least a first threshold quality 304, where prefetch enable data 622 is used to enable one or more prefetch throttling modes, including first prefetch throttling mode M1, second prefetch throttling mode M2, and third prefetch throttling mode M3; and
One or more threshold qualities 624 for determining the prefetch throttling modes, e.g., threshold qualities 304 and 310, stride history length thresholds for stride prefetching.

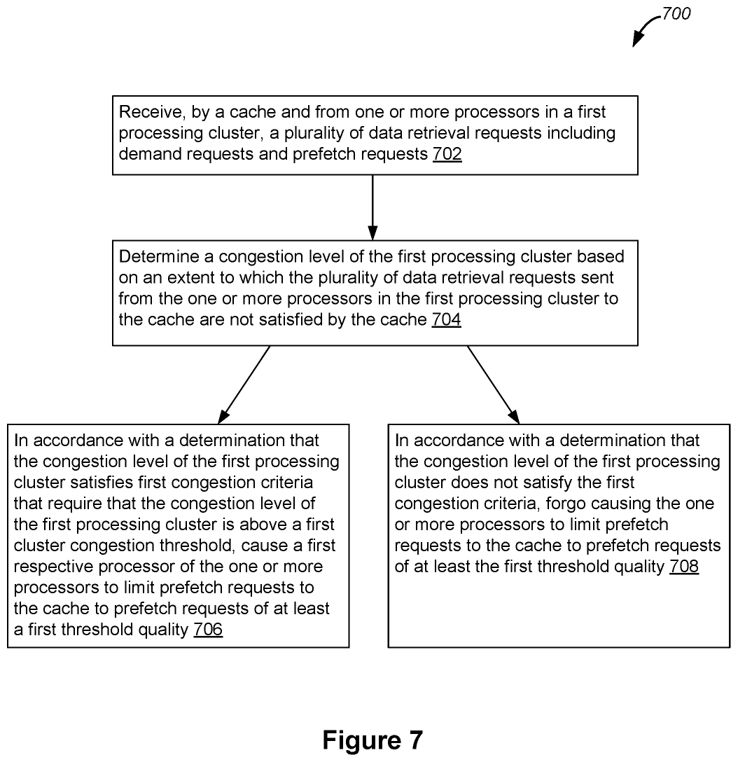

FIG. 7 is a flow chart of an example method 700 of controlling cache prefetching in a first processing cluster 202-1, in accordance with some implementations. First processing cluster 202-1 includes one or more processors 204 and a cache 212-1 coupled to one or more processors 204 in first processing cluster 202-1. Cache 212-1 receives (702), from one or more processors 204 in first processing cluster 202-1, a plurality of data retrieval requests including demand requests and prefetch requests. Prefetch throttling circuitry (e.g., throttler 216) is coupled to one or more processors 204 in first processing cluster 202-1.

Prefetch throttling circuitry determines (704) a congestion level of first processing cluster 202-1 based on an extent to which the plurality of data retrieval requests sent from one or more processors 204 in first processing cluster 202-1 to cache 212-1 are not satisfied by cache 212-1. The plurality of data retrieval requests optionally include all data retrieval requests sent from one or more processors 204 to cache 212-1 within a predefined period of time. In some implementations, the congestion level of first processing cluster 202-1 is determined based on an extent to which the plurality of data retrieval requests sent from one or more processors 204 in first processing cluster 202-1 to cache 212-1 are not satisfied by cache 212-1, without regard to which of one or more processors 204 sent the plurality of data retrieval requests.

In some implementations, determining the congestion level of first processing cluster 202-1 includes comparing the number of plurality of data retrieval requests, sent from one or more processors 204 in first processing cluster 202-1 to cache 212-1, that are not satisfied by cache 212-1 to one or more cache miss thresholds (e.g., thresholds 302′ and 308′ in FIG. 3). Further, in some implementations, the one or more cache miss thresholds are determined based on a system congestion level of the device. Additionally, in some implementations, the extent to which the plurality of data retrieval requests, sent from one or more processors 204 in first processing cluster 202-1 to cache 212-1, are not satisfied by cache 212-1 is represented by one or more historical congestion levels (which are stored in a cluster congestion level history 318) for first processing cluster 202-1, and the congestion level of first processing cluster 202-1 is determined based on the one or more historical congestion levels. For example, the one or more historical congestion levels for the first processing cluster includes a current congestion level 318A. In accordance with a determination that the current congestion level of the first processing cluster indicates a higher congestion level than the congestion level of the first processing cluster, the prefetch throttling circuitry increases the congestion level of the first processing cluster 202-1. In accordance with a determination that the one or more historical congestion levels of the first processing cluster 202-1 indicate a lower congestion level than the congestion level of the first processing cluster 202-1 (e.g., all of the one or more historical congestion levels in history 318 are lower than the congestion level), the prefetch throttling circuitry decreases the congestion level of the first processing cluster 202-1. By these means, the congestion level of the first processing cluster 202-1 responds promptly to an increasing current congestion level 318A and exits slowly out of a relatively high congestion level.

In accordance with a determination that the congestion level of first processing cluster 202-1 satisfies first congestion criteria that require that the congestion level of first processing cluster 202-1 is above a first cluster congestion threshold 302, the prefetch throttling circuitry causes (706) a first respective processor 204-1 of one or more processors 204 to limit prefetch requests to cache 212-1 to prefetch requests of at least a first threshold quality 304. Conversely, in accordance with a determination that the congestion level of first processing cluster 202-1 does not satisfy the first congestion criteria, the prefetch throttling circuitry forgoes (708) causing one or more processors 204 to limit prefetch requests to cache 212-1 to prefetch requests of at least the first threshold quality 304.

In some implementations, the first threshold quality 304 is selected from a set of quality thresholds based on a system congestion level of the device (e.g., a combined system congestion level 410 in FIG. 4). More details on threshold quality selection are described with reference to FIGS. 5A and 5B.

In some implementations, in accordance with a determination that the congestion level of first processing cluster 202-1 satisfies second congestion criteria, different from the first congestion criteria, that require that the congestion level of first processing cluster 202-1 is above a second cluster congestion threshold 308 that is above the first cluster congestion threshold 302, the prefetch throttling circuitry causes first respective processor 204-1 to limit prefetch requests to cache 212-1 to prefetch requests of at least a second threshold quality 310 that is higher than the first threshold quality 304. Further, in some implementations, in accordance with a determination that the congestion level of first processing cluster 202-1 satisfies third congestion criteria, different from the first congestion criteria, the prefetch throttling circuitry causes the first respective processor to forgo transmitting prefetch requests to cache 212-1, e.g., in a throttle all mode M4. Further, in some implementations, the third congestion criteria include a requirement that a system congestion level of the device (e.g., first congestion level history 402 of cache 220) satisfies a system congestion condition 316.

In some implementations, in accordance with a determination that a congestion level of a second respective processor 204-M is below a processor congestion threshold 336, regardless of the congestion level of first processing cluster 202-1, the prefetch throttling circuitry forgoes limiting prefetch requests from the second respective processor 204-M to cache 212-1, wherein the congestion level of second respective processor 204-M is determined based on an extent to which data retrieval requests sent from second respective processor 204-M to cache 212-1 are not satisfied by cache 212-1.

It is noted that in some embodiments, the first respective processor 204-1 of the one or more processors is caused to limit prefetch requests to cache 212-1 to prefetch requests of at least the first threshold quality, in accordance with a determination that a congestion level of the first respective processor 204-1 is above a processor congestion threshold 336. That said, in an example, if the congestion level of the first respective processor 204-1 is “H”, the prefetch requests from the first respective processor 204-1 are limited to at least the first threshold quality, and if the congestion level of the first respective processor 204-1 is “L”, the prefetch requests from the first respective processor 204-1 are not limited. In some embodiments, the congestion level of the first respective processor 204-1 is determined based on one or more historical congestion levels (e.g., in history 334 in FIG. 3) including a current congestion level 334A for the first respective processor 204-1. In accordance with a determination that the current congestion level of the first respective processor 204-1 indicates a higher congestion level than the congestion level of the first respective processor 204-1, the prefetch throttling circuitry increases the congestion level of the first respective processor 204-1. In accordance with a determination that the one or more historical congestion levels of the first respective processor indicate a lower congestion level than the congestion level of the first respective processor 204-1 (e.g., all of the historical congestion levels 334 are lower than the congestion level of the first respective processor 204-1), the prefetch throttling circuitry decreases the congestion level of the first respective processor 204-1. By these means, the congestion level of the first respective processor 204-1 responds promptly to an increasing current congestion level 334A and exits slowly out of a relatively high congestion level.

In some implementations, a second processing cluster 202-M includes one or more second processors 206 different from one or more processors 204 of first processing cluster 202-1. The prefetch throttling circuitry limits prefetch requests by first processing cluster 202-1 independently of whether prefetch requests from one or more second processors 206 of second processing cluster 202-M are limited.

FIG. 8 is a flow chart of another example method 800 of controlling cache prefetching in a processing cluster 202, in accordance with some implementations. An electronic device includes a plurality of processing clusters 202, first memory (e.g., cache 220 coupled to clusters 202 on SOC 102), and second memory (e.g., memory 104 external to the SOC 102 and including DRAM). Each cluster (e.g., first processing cluster 202-1) includes one or more respective processors. The first memory is coupled to the plurality of processing clusters 202. The second memory is coupled to the plurality of processing clusters 202, and receives (802) data retrieval requests sent from the plurality of processing clusters 202 to the first memory that are not satisfied by the first memory. A prefetch throttling circuitry (e.g., throttler 216) is coupled to the one or more respective processors in each of the plurality of processing clusters 202. A current congestion level of the first memory is obtained (804) based on a number of outstanding in-flight requests received by the first memory. A first congestion level history (e.g., history 402 in FIG. 5) is maintained (806) to include the obtained current congestion level of the first memory. A current congestion level of the second memory is obtained (808) based on a number of outstanding in-flight requests received by the second memory. A second congestion level history (e.g., history 404 in FIG. 5) is maintained (810) to include the obtained current congestion level of the second memory.

The prefetch throttling circuitry causes (812) a respective processing cluster to limit prefetch requests from the respective processing cluster 202 based on at least one of the obtained current congestion level of the first memory and the obtained current congestion level of the second memory.

In some implementations, the prefetch throttling circuitry determines a respective throttling level, of a plurality of throttling levels, for respective processing cluster 202 based on a congestion level of respective processing cluster 202. Further, in some implementations, a combined system congestion level 410 is determined based on the obtained current congestion level of the first memory and the obtained current congestion level of the second memory. In an example, the combined system congestion level 410 is equal to a greater one of the obtained current congestion level of the first memory and the obtained current congestion level of the second memory. The prefetch throttling circuitry determines the respective throttling level for respective processing cluster 202 based on comparing the congestion level of respective processing cluster 202 to one or more cluster congestion thresholds 302 and 308 that vary based on the combined system congestion level 410. Further, in some implementations, the prefetch throttling circuitry causes respective processing cluster 202 to limit prefetch requests to prefetch requests of at least a respective threshold quality 304 or 310, and the respective threshold quality 304 or 310 corresponds to the respective throttling level for the respective processing cluster 202 and is determined based on the combined congestion level 410. More details on determining the threshold quality 304 or 310 are discussed above with reference to FIGS. 5A and 5B.

In some implementations, the prefetch throttling circuitry causes respective processing cluster 202 to limit prefetch requests from respective processing cluster 202 in accordance with a highest throttling level 420 based on the first congestion level history 402 of the first memory including the obtained current congestion level of the first memory, e.g., in a throttle all mode M4. Further, in some implementations, the prefetch throttling circuitry causes respective processing cluster 202 to limit prefetch requests from respective processing cluster 202 based on a subset of the first congestion level history 402 and on second congestion level history 404. Additionally, in some implementations, the prefetch throttling circuitry causes respective processing cluster 202 to limit prefetch requests from respective processing cluster 202 in accordance with highest throttling level 420 based on a determination that first congestion level history 402 includes more than a first threshold number of determined congestion levels (e.g., “H”) indicating a respective congestion level of the first memory. Further, in some implementations, the prefetch throttling circuitry causes respective processing cluster 202 to forgo limiting prefetch requests from respective processing cluster 202 in accordance with highest throttling level 420 based on a determination that the first congestion level history 402 includes less than a second threshold number of determined congestion levels indicating the respective congestion level of the first memory. Further, in some implementations, limiting prefetch requests from respective processing cluster 202 in accordance with highest throttling level 420 includes limiting all prefetch requests from respective processing cluster 202, e.g., in a throttle all mode M4.

It is noted that in some implementations, limiting prefetch requests from respective processing cluster 202 according to highest throttling level 420 is also implemented based on a combination of (1) the congestion level of respective processing cluster 202 and (2) the obtained current, congestion level, first congestion level history 402, or a subset of first congestion level history 402 of the first memory (e.g., cache 220). For example, highest throttling level 420 is applied to limit prefetching, when the congestion level of processing cluster 202 is above cluster congestion threshold 308 and the first congestion level history 402 of cache 220 satisfies a first system congestion condition 316 (e.g., in which first congestion level history 402 of cache 220 includes more than a first threshold number of determined congestion levels (e.g., “H”) indicating a respective congestion level of the first memory).

In some implementations, the electronic device determines a first congestion level of the first memory (e.g., congestion level 406 of cache 220 in FIG. 4). Specifically, in accordance with a determination that the obtained current congestion level of the first memory indicates a higher congestion level than the first congestion level, the prefetch throttling circuitry increases the first congestion level. In accordance with a determination that the first congestion level history 402 indicates a lower congestion level than the first congestion level (e.g., the entire first congestion level history 402 is lower than the first congestion level), the prefetch throttling circuitry decreases the first congestion level. Similarly, the electronic device determines a second congestion level of the second memory (e.g., congestion level 408 of memory 104 in FIG. 4). Specifically, in accordance with a determination that the obtained current congestion level of the second memory indicates a higher congestion level than the second congestion level, the prefetch throttling circuitry increases the second congestion level. In accordance with a determination that second congestion level history 404 indicates a lower congestion level than the second congestion level (e.g., the entire second congestion level history 404 is lower than the second congestion level), the prefetch throttling circuitry decreases the second congestion level. The prefetch throttling circuitry causes respective processing cluster 202 to limit prefetch requests from respective processing cluster 202 based on the first congestion level and the second congestion level. By these means, the congestion level of the first or second memory responds promptly to an increasing current congestion level of the first or second memory and exits slowly out of a relatively high congestion level.

It should be understood that the particular order in which the operations in FIGS. 7 and 8 have been described are merely exemplary and are not intended to indicate that the described order is the only order in which the operations could be performed. One of ordinary skill in the art would recognize various ways to reorder the operations described herein. Additionally, it should be noted that details of other processes described herein with respect to methods 700 and 800 (e.g., FIGS. 7 and 8) are also applicable in an exchangeable manner. For brevity, these details are not repeated here.

Implementation examples are described in at least the following numbered clauses:

Clause 1. An electronic device, comprising: a first processing cluster including one or more processors; and a cache coupled to the one or more processors in the first processing cluster, wherein the cache is configured to receive, from the one or more processors in the first processing cluster, a plurality of data retrieval requests including demand requests and prefetch requests; and prefetch throttling circuitry coupled to the one or more processors in the first processing cluster, wherein the prefetch throttling circuitry is configured to: determine a congestion level of the first processing cluster based on an extent to which the plurality of data retrieval requests sent from the one or more processors in the first processing cluster to the cache are not satisfied by the cache; and in accordance with a determination that the congestion level of the first processing cluster satisfies first congestion criteria that require that the congestion level of the first processing cluster is above a first cluster congestion threshold, cause a first respective processor of the one or more processors to limit prefetch requests to the cache to prefetch requests of at least a first threshold quality; and in accordance with a determination that the congestion level of the first processing cluster does not satisfy the first congestion criteria, forgo causing the one or more processors to limit prefetch requests to the cache to prefetch requests of at least the first threshold quality.

Clause 2. The device of clause 1, wherein the prefetch throttling circuitry is configured to, in accordance with a determination that the congestion level of the first processing cluster satisfies second congestion criteria, different from the first congestion criteria, that require that the congestion level of the first processing cluster is above a second cluster congestion threshold that is above the first cluster congestion threshold, cause the first respective processor to limit prefetch requests to the cache to prefetch requests of at least a second threshold quality that is higher than the first threshold quality.

Clause 3. The device of any of clauses 1-2, wherein the prefetch throttling circuitry is configured to, in accordance with a determination that the congestion level of the first processing cluster satisfies third congestion criteria, different from the first congestion criteria, cause the first respective processor to forgo transmitting prefetch requests to the cache.

Clause 4. The device of clause 3, wherein the third congestion criteria include a requirement that a system congestion level of the device satisfies a system congestion condition.

Clause 5. The device of any of clauses 1-4, wherein the extent to which the plurality of data retrieval requests, sent from the one or more processors in the first processing cluster to the cache, are not satisfied by the cache is represented by one or more historical congestion levels for the first processing cluster, and the congestion level of the first processing cluster is determined based on the one or more historical congestion levels.

Clause 6. The device of clause 5, wherein the one or more historical congestion levels of the first processing cluster includes a current congestion level, and the prefetch throttling circuitry is configured to: in accordance with a determination that the current congestion level of the first processing cluster indicates a higher congestion level than the congestion level of the first processing cluster, increase the congestion level of the first processing cluster; and in accordance with a determination that the one or more historical congestion levels of the first processing cluster indicate a lower congestion level than the congestion level of the first processing cluster, decrease the congestion level of the first processing cluster.

Clause 7. The device of any of clauses 1-6, wherein the congestion level of the first processing cluster is determined based on an extent to which the plurality of data retrieval requests sent from the one or more processors in the first processing cluster to the cache are not satisfied by the cache, without regard to which of the one or more processors sent the plurality of data retrieval requests.

Clause 8. The device of any of clauses 1-7, wherein determining the congestion level of the first processing cluster includes comparing the number of plurality of data retrieval requests, sent from the one or more processors in the first processing cluster to the cache, that are not satisfied by the cache to one or more cache miss thresholds.

Clause 9. The device of clause 8, wherein the one or more cache miss thresholds are determined based on a system congestion level of the device.

Clause 10. The device of any of clauses 1-9, wherein the plurality of data retrieval requests include all data retrieval requests sent from the one or more processors to the cache within a predefined period of time.

Clause 11. The device of any of clauses 1-10, wherein the first threshold quality is selected from a set of quality thresholds based on a system congestion level of the device.

Clause 12. The device of any of clauses 1-11, wherein the prefetch throttling circuitry is configured to: in accordance with a determination that a congestion level of a second respective processor is below a processor congestion threshold, regardless of the congestion level of the first processing cluster, forgo limiting prefetch requests from the second respective processor to the cache, wherein the congestion level of the second respective processor is determined based on an extent to which data retrieval requests sent from the second respective processor to the cache are not satisfied by the cache.

Clause 13. The device of any of clauses 1-12, wherein causing the first respective processor of the one or more processors to limit prefetch requests to the cache to prefetch requests of at least the first threshold quality further comprises: determining that a congestion level of the first respective processor is above a processor congestion threshold.

Clause 14. The device of clause 13, wherein the congestion level of the first respective processor is determined based on one or more historical congestion levels including a current congestion level of the first respective processor, and the prefetch throttling circuitry is configured to: in accordance with a determination that the current congestion level of the first respective processor indicates a higher congestion level than the congestion level of the first respective processor, increase the congestion level of the first respective processor; and in accordance with a determination that the one or more historical congestion levels of the first respective processor indicate a lower congestion level than the congestion level of the first respective processor, decrease the congestion level of the first respective processor.

Clause 15. The device of any of clauses 1-14, further including a second processing cluster including one or more second processors different from the one or more processors of the first processing cluster, wherein the prefetch throttling circuitry limits prefetch requests by the first processing cluster independently of whether prefetch requests from the one or more second processors of the second processing cluster are limited.

Clause 16. A data caching method, comprising: at an electronic device having a first processing cluster including one or more processors, a cache coupled to the one or more processors in the first processing cluster, and prefetch throttling circuitry coupled to the one or more processors in the first processing cluster, wherein the cache is configured to receive, from the one or more processors in the first processing cluster, a plurality of data retrieval requests including demand requests and prefetch requests: determining a congestion level of the first processing cluster based on an extent to which the plurality of data retrieval requests sent from the one or more processors in the first processing cluster to the cache are not satisfied by the cache; and in accordance with a determination that the congestion level of the first processing cluster satisfies first congestion criteria that require that the congestion level of the first processing cluster is above a first cluster congestion threshold, causing a first respective processor of the one or more processors to limit prefetch requests to the cache to prefetch requests of at least a first threshold quality; and in accordance with a determination that the congestion level of the first processing cluster does not satisfy the first congestion criteria, forgoing causing the one or more processors to limit prefetch requests to the cache to prefetch requests of at least the first threshold quality.

Clause 17. The method of clause 16, further comprising, at the prefetch throttling circuitry: in accordance with a determination that the congestion level of the first processing cluster satisfies second congestion criteria, different from the first congestion criteria, that require that the congestion level of the first processing cluster is above a second cluster congestion threshold that is above the first cluster congestion threshold, causing the first respective processor to limit prefetch requests to the cache to prefetch requests of at least a second threshold quality that is higher than the first threshold quality.

Clause 18. The method of clause 16 or 17, further comprising, at the prefetch throttling circuitry: in accordance with a determination that the congestion level of the first processing cluster satisfies third congestion criteria, different from the first congestion criteria, causing the first respective processor to forgo transmitting prefetch requests to the cache.

Clause 19. The method of clause 18, wherein the third congestion criteria include a requirement that a system congestion level of the device satisfies a system congestion condition.

Clause 20. The method of any of clauses 16-19, wherein the extent to which the plurality of data retrieval requests, sent from the one or more processors in the first processing cluster to the cache, are not satisfied by the cache is represented by one or more historical congestion levels for the first processing cluster, and the congestion level of the first processing cluster is determined based on the one or more historical congestion levels.

Clause 21. The method of clause 20, wherein the one or more historical congestion levels of the first processing cluster includes a current congestion level, the method further comprising, at the prefetch throttling circuitry: in accordance with a determination that the current congestion level of the first processing cluster indicates a higher congestion level than the congestion level of the first processing cluster, increasing the congestion level of the first processing cluster; and in accordance with a determination that the one or more historical congestion levels of the first processing cluster indicate a lower congestion level than the congestion level of the first processing cluster, decreasing the congestion level of the first processing cluster.

Clause 22. The method of any of clauses 16-21, wherein the congestion level of the first processing cluster is determined based on an extent to which the plurality of data retrieval requests sent from the one or more processors in the first processing cluster to the cache are not satisfied by the cache, without regard to which of the one or more processors sent the plurality of data retrieval requests.

Clause 23. The method of any of clauses 16-22, wherein determining the congestion level of the first processing cluster includes comparing the number of plurality of data retrieval requests, sent from the one or more processors in the first processing cluster to the cache, that are not satisfied by the cache to one or more cache miss thresholds.

Clause 24. The method of clause 23, wherein the one or more cache miss thresholds are determined based on a system congestion level of the device.

Clause 25. The method of any of clauses 16-24, wherein the plurality of data retrieval requests include all data retrieval requests sent from the one or more processors to the cache within a predefined period of time.

Clause 26. The method of any of clauses 16-25, wherein the first threshold quality is selected from a set of quality thresholds based on a system congestion level of the device.

Clause 27. The method of any of clauses 16-26, further comprising, at the prefetch throttling circuitry: in accordance with a determination that a congestion level of a second respective processor is below a processor congestion threshold, regardless of the congestion level of the first processing cluster, forgoing limiting prefetch requests from the second respective processor to the cache, wherein the congestion level of the second respective processor is determined based on an extent to which data retrieval requests sent from the second respective processor to the cache are not satisfied by the cache.

Clause 28. The method of any of clauses 16-27, wherein causing the first respective processor of the one or more processors to limit prefetch requests to the cache to prefetch requests of at least the first threshold quality further comprises: determining that a congestion level of the first respective processor is above a processor congestion threshold.

Clause 29. The method of clause 28, wherein the congestion level of the first respective processor is determined based on one or more historical congestion levels including a current congestion level of the first respective processor, the method further comprising, at the prefetch throttling circuitry: in accordance with a determination that the current congestion level of the first respective processor indicates a higher congestion level than the congestion level of the first respective processor, increasing the congestion level of the first respective processor; and in accordance with a determination that the one or more historical congestion levels of the first respective processor indicate a lower congestion level than the congestion level of the first respective processor, decreasing the congestion level of the first respective processor.

Clause 30. The method of any of clauses 16-29, the electronic device further including a second processing cluster including one or more second processors different from the one or more processors of the first processing cluster, wherein the prefetch throttling circuitry limits prefetch requests by the first processing cluster independently of whether prefetch requests from the one or more second processors of the second processing cluster are limited.

Clause 31. A non-transitory computer-readable medium, having instructions stored thereon for performing a method of any of clauses 16-30.

Clause 32. An apparatus for caching data at an electronic device having a first processing cluster including one or more processors, a cache coupled to the one or more processors in the first processing cluster, and prefetch throttling circuitry coupled to the one or more processors in the first processing cluster, wherein the cache is configured to receive, from the one or more processors in the first processing cluster, a plurality of data retrieval requests including demand requests and prefetch requests, the apparatus comprising: means for performing a method of any of clauses 16-30.

Clause 33. An electronic device, comprising: a plurality of processing clusters, each including one or more respective processors; first memory coupled to the plurality of processing clusters; and second memory coupled to the plurality of processing clusters, wherein the second memory is configured to receive data retrieval requests from the plurality of processing clusters to the first memory that are not satisfied by the first memory; and prefetch throttling circuitry coupled to the one or more respective processors in each of the plurality of processing clusters; wherein: the device is configured to: obtain a current congestion level of the first memory based on a number of outstanding in-flight requests received by the first memory, and maintain a first congestion level history that includes the obtained current congestion level of the first memory; obtain a current congestion level of the second memory based on a number of outstanding in-flight requests received by the second memory, and maintain a second congestion level history that includes the obtained current congestion level of the second memory; and the prefetch throttling circuitry is configured to cause a respective processing cluster to limit prefetch requests from the respective processing cluster based on at least one of the obtained current congestion level of the first memory and the obtained current congestion level of the second memory.

Clause 34. The device of clause 33, wherein the prefetch throttling circuitry is configured to determine a respective throttling level, of a plurality of throttling levels, for the respective processing cluster based on a congestion level of the respective processing cluster.

Clause 35. The device of clause 34, configured to determine a combined system congestion level based on the obtained current congestion level of the first memory and the obtained current congestion level of the second memory, wherein the prefetch throttling circuitry is configured to determine the respective throttling level for the respective processing cluster based on comparing the congestion level of the respective processing cluster to one or more cluster congestion thresholds that are determined based on the combined system congestion level.

Clause 36. The device of clause 35, wherein the prefetch throttling circuitry is configured to cause the respective processing cluster to limit prefetch requests to prefetch requests of at least a respective threshold quality that corresponds to the respective throttling level for the respective processing cluster and is determined based on the combined system congestion level.

Clause 37. The device of any of clauses 33-36, wherein the prefetch throttling circuitry is configured to cause the respective processing cluster to limit prefetch requests from the respective processing cluster in accordance with a highest throttling level based on the first congestion level history of the first memory.

Clause 38. The device of clause 37, wherein: the prefetch throttling circuitry is configured to cause the respective processing cluster to limit prefetch requests from the respective processing cluster based on a subset of the first congestion level history and on the second congestion level history.

Clause 39. The device of any of clauses 33-37, wherein the prefetch throttling circuitry is configured to cause the respective processing cluster to limit prefetch requests from the respective processing cluster in accordance with the highest throttling level based on a determination that the first congestion level history includes more than a first threshold number of determined congestion levels indicating a respective congestion level of the first memory.

Clause 40. The device of clause 39, wherein the prefetch throttling circuitry is configured to cause the respective processing cluster to forgo limiting prefetch requests from the respective processing cluster in accordance with the highest throttling level based on a determination that the first congestion level history includes less than a second threshold number of determined congestion levels indicating the respective congestion level of the first memory.

Clause 41. The device of any of clauses 37-40, wherein limiting prefetch requests from the respective processing cluster in accordance with the highest throttling level includes limiting all prefetch requests from the respective processing cluster.

Clause 42. The device of any of clauses 33-41, configured to: determine a first congestion level of the first memory, including: in accordance with a determination that the obtained current congestion level of the first memory indicates a higher congestion level than the first congestion level, increase the first congestion level; and in accordance with a determination that the first congestion level history indicates a lower congestion level than the first congestion level, decrease the first congestion level; and determine a second congestion level of the second memory, including: in accordance with a determination that the obtained current congestion level of the second memory indicates a higher congestion level than the second congestion level, increase the second congestion level; and in accordance with a determination that the second congestion level history indicates a lower congestion level than the second congestion level, decrease the second congestion level; wherein the prefetch throttling circuitry is configured to cause the respective processing cluster to limit prefetch requests from the respective processing cluster based on the first congestion level and the second congestion level.

Clause 43. A data caching method, comprising: at an electronic device including a plurality of processing clusters, first memory coupled to the plurality of processing clusters, second memory coupled to the plurality of processing clusters, and prefetch throttling circuitry coupled to the one or more respective processors in each of the plurality of processing clusters, each processing cluster including one or more respective processors, wherein the second memory is configured to receive data retrieval requests from the plurality of processing clusters to the first memory that are not satisfied by the first memory: obtaining a current congestion level of the first memory based on a number of outstanding in-flight requests received by the first memory, and maintain a first congestion level history that includes the obtained current congestion level of the first memory; obtaining a current congestion level of the second memory based on a number of outstanding in-flight requests received by the second memory, and maintain a second congestion level history that includes the obtained current congestion level of the second memory; and causing a respective processing cluster to limit prefetch requests from the respective processing cluster based on at least one of the obtained current congestion level of the first memory and the obtained current congestion level of the second memory.

Clause 44. The method of clause 43, further comprising, at the prefetch throttling circuitry: determining a respective throttling level, of a plurality of throttling levels, for the respective processing cluster based on a congestion level of the respective processing cluster.

Clause 45. The method of clause 44, further comprising: determining a combined system congestion level based on the obtained current congestion level of the first memory and the obtained current congestion level of the second memory, wherein the prefetch throttling circuitry is configured to determine the respective throttling level for the respective processing cluster based on comparing the congestion level of the respective processing cluster to one or more cluster congestion thresholds that are determined based on the combined system congestion level.

Clause 46. The method of clause 45, further comprising, at the prefetch throttling circuitry: causing the respective processing cluster to limit prefetch requests to prefetch requests of at least a respective threshold quality that corresponds to the respective throttling level for the respective processing cluster and is determined based on the combined system congestion level.

Clause 47. The method of any of clauses 43-46, further comprising, at the prefetch throttling circuitry: causing the respective processing cluster to limit prefetch requests from the respective processing cluster in accordance with a highest throttling level based on the first congestion level history of the first memory.

Clause 48. The method of clause 47, further comprising, at the prefetch throttling circuitry: causing the respective processing cluster to limit prefetch requests from the respective processing cluster based on a subset of the first congestion level history and on the second congestion level history.

Clause 49. The method of any of clauses 43-47, further comprising, at the prefetch throttling circuitry: causing the respective processing cluster to limit prefetch requests from the respective processing cluster in accordance with the highest throttling level based on a determination that the first congestion level history includes more than a first threshold number of determined congestion levels indicating a respective congestion level of the first memory.

Clause 50. The method of clause 49, further comprising, at the prefetch throttling circuitry: causing the respective processing cluster to forgo limiting prefetch requests from the respective processing cluster in accordance with the highest throttling level based on a determination that the first congestion level history includes less than a second threshold number of determined congestion levels indicating the respective congestion level of the first memory.

Clause 51. The method of any of clauses 47-50, wherein limiting prefetch requests from the respective processing cluster in accordance with the highest throttling level includes limiting all prefetch requests from the respective processing cluster.

Clause 52. The method of any of clauses 43-51, further comprising: determining a first congestion level of the first memory, including: in accordance with a determination that the obtained current congestion level of the first memory indicates a higher congestion level than the first congestion level, increasing the first congestion level; and in accordance with a determination that the first congestion level history indicates a lower congestion level than the first congestion level, decreasing the first congestion level; and determining a second congestion level of the second memory, including: in accordance with a determination that the obtained current congestion level of the second memory indicates a higher congestion level than the second congestion level, increasing the second congestion level; and in accordance with a determination that the second congestion level history indicates a lower congestion level than the second congestion level, decreasing the second congestion level; wherein the prefetch throttling circuitry is configured to cause the respective processing cluster to limit prefetch requests from the respective processing cluster based on the first congestion level and the second congestion level.

Clause 53. A non-transitory computer-readable medium, having instructions stored thereon for performing a method of any of methods 43-52.

Clause 54. An apparatus for caching data at an electronic device including a plurality of processing clusters, first memory coupled to the plurality of processing clusters, second memory coupled to the plurality of processing clusters, and prefetch throttling circuitry coupled to the one or more respective processors in each of the plurality of processing clusters, each processing cluster including one or more respective processors, wherein the second memory is configured to receive data retrieval requests from the plurality of processing clusters to the first memory that are not satisfied by the first memory, the apparatus comprising means for performing a method of any of clauses 43-52.

The above description has been provided with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles disclosed and their practical applications, to thereby enable others to best utilize the disclosure and various embodiments with various modifications as are suited to the particular use contemplated.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof

What is claimed is:

1. An electronic device, comprising:
a first processing cluster including one or more processors; and
a cache coupled to the one or more processors in the first processing cluster, wherein the cache is configured to receive, from the one or more processors in the first processing cluster, a plurality of data retrieval requests including demand requests and prefetch requests; and
prefetch throttling circuitry coupled to the one or more processors in the first processing cluster, wherein the prefetch throttling circuitry is configured to:
determine a congestion level of the first processing cluster based on an extent to which the plurality of data retrieval requests sent from the one or more processors in the first processing cluster to the cache are not satisfied by the cache; and
in accordance with a determination that the congestion level of the first processing cluster satisfies first congestion criteria that require that the congestion level of the first processing cluster is above a first cluster congestion threshold, cause a first respective processor of the one or more processors to limit prefetch requests to the cache to prefetch requests of at least a first threshold quality; and
in accordance with a determination that the congestion level of the first processing cluster does not satisfy the first congestion criteria, forgo causing the one or more processors to limit prefetch requests to the cache to prefetch requests of at least the first threshold quality.

2. The electronic device of claim 1, wherein the prefetch throttling circuitry is configured to, in accordance with a determination that the congestion level of the first processing cluster satisfies second congestion criteria, different from the first congestion criteria, that require that the congestion level of the first processing cluster is above a second cluster congestion threshold that is above the first cluster congestion threshold, cause the first respective processor to limit prefetch requests to the cache to prefetch requests of at least a second threshold quality that is higher than the first threshold quality.

3. The electronic device of claim 1, wherein the prefetch throttling circuitry is configured to, in accordance with a determination that the congestion level of the first processing cluster satisfies third congestion criteria, different from the first congestion criteria, cause the first respective processor to forgo transmitting prefetch requests to the cache.

4. The electronic device of claim 3, wherein the third congestion criteria include a requirement that a system congestion level of the device satisfies a system congestion condition.

5. The electronic device of claim 1, wherein the extent to which the plurality of data retrieval requests, sent from the one or more processors in the first processing cluster to the cache, are not satisfied by the cache is represented by one or more historical congestion levels for the first processing cluster, and the congestion level of the first processing cluster is determined based on the one or more historical congestion levels.

6. The electronic device of claim 5, wherein the one or more historical congestion levels of the first processing cluster includes a current congestion level, and the prefetch throttling circuitry is configured to:
in accordance with a determination that the current congestion level of the first processing cluster indicates a higher congestion level than the congestion level of the first processing cluster, increase the congestion level of the first processing cluster; and
in accordance with a determination that the one or more historical congestion levels of the first processing cluster indicate a lower congestion level than the congestion level of the first processing cluster, decrease the congestion level of the first processing cluster.

7. The electronic device of claim 1, wherein the congestion level of the first processing cluster is determined based on an extent to which the plurality of data retrieval requests sent from the one or more processors in the first processing cluster to the cache are not satisfied by the cache, without regard to which of the one or more processors sent the plurality of data retrieval requests.

8. The electronic device of claim 1, wherein determining the congestion level of the first processing cluster includes comparing the number of plurality of data retrieval requests, sent from the one or more processors in the first processing cluster to the cache, that are not satisfied by the cache to one or more cache miss thresholds.

9. The electronic device of claim 8, wherein the one or more cache miss thresholds are determined based on a system congestion level of the device.

10. The electronic device of claim 1, wherein the plurality of data retrieval requests include all data retrieval requests sent from the one or more processors to the cache within a predefined period of time.

11. The electronic device of claim 1, wherein the first threshold quality is selected from a set of quality thresholds based on a system congestion level of the device.

12. The electronic device of claim 1, wherein the prefetch throttling circuitry is configured to:
in accordance with a determination that a congestion level of a second respective processor is below a processor congestion threshold, regardless of the congestion level of the first processing cluster, forgo limiting prefetch requests from the second respective processor to the cache, wherein the congestion level of the second respective processor is determined based on an extent to which data retrieval requests sent from the second respective processor to the cache are not satisfied by the cache.

13. The electronic device of claim 1, wherein causing the first respective processor of the one or more processors to limit prefetch requests to the cache to prefetch requests of at least the first threshold quality further comprises:
determining that a congestion level of the first respective processor is above a processor congestion threshold.

14. The electronic device of claim 13, wherein the congestion level of the first respective processor is determined based on one or more historical congestion levels including a current congestion level of the first respective processor, and wherein the prefetch throttling circuitry is configured to:
in accordance with a determination that the current congestion level of the first respective processor indicates a higher congestion level than the congestion level of the first respective processor, increase the congestion level of the first respective processor; and
in accordance with a determination that the one or more historical congestion levels of the first respective processor indicate a lower congestion level than the congestion level of the first respective processor, decrease the congestion level of the first respective processor.

15. The electronic device of claim 1, further including a second processing cluster including one or more second processors different from the one or more processors of the first processing cluster, wherein the prefetch throttling circuitry limits prefetch requests by the first processing cluster independently of whether prefetch requests from the one or more second processors of the second processing cluster are limited.

16. A data caching method, comprising:
at an electronic device having a first processing cluster including one or more processors, a cache coupled to the one or more processors in the first processing cluster, and prefetch throttling circuitry coupled to the one or more processors in the first processing cluster, wherein the cache is configured to receive, from the one or more processors in the first processing cluster, a plurality of data retrieval requests including demand requests and prefetch requests:
determining a congestion level of the first processing cluster based on an extent to which the plurality of data retrieval requests sent from the one or more processors in the first processing cluster to the cache are not satisfied by the cache; and
in accordance with a determination that the congestion level of the first processing cluster satisfies first congestion criteria that require that the congestion level of the first processing cluster is above a first cluster congestion threshold, causing a first respective processor of the one or more processors to limit prefetch requests to the cache to prefetch requests of at least a first threshold quality; and
in accordance with a determination that the congestion level of the first processing cluster does not satisfy the first congestion criteria, forgoing causing the one or more processors to limit prefetch requests to the cache to prefetch requests of at least the first threshold quality.

17. The method of claim 16, further comprising, at the prefetch throttling circuitry:
in accordance with a determination that the congestion level of the first processing cluster satisfies second congestion criteria, different from the first congestion criteria, that require that the congestion level of the first processing cluster is above a second cluster congestion threshold that is above the first cluster congestion threshold, causing the first respective processor to limit prefetch requests to the cache to prefetch requests of at least a second threshold quality that is higher than the first threshold quality.

18. The method of claim 16, further comprising, at the prefetch throttling circuitry:
in accordance with a determination that the congestion level of the first processing cluster satisfies third congestion criteria, different from the first congestion criteria, causing the first respective processor to forgo transmitting prefetch requests to the cache.

19. The method of claim 18, wherein the third congestion criteria include a requirement that a system congestion level of the device satisfies a system congestion condition.

20. The method of claim 16, wherein the extent to which the plurality of data retrieval requests, sent from the one or more processors in the first processing cluster to the cache, are not satisfied by the cache is represented by one or more historical congestion levels for the first processing cluster, and the congestion level of the first processing cluster is determined based on the one or more historical congestion levels.

21. The method of claim 20, wherein the one or more historical congestion levels of the first processing cluster includes a current congestion level, the method further comprising, at the prefetch throttling circuitry:
in accordance with a determination that the current congestion level of the first processing cluster indicates a higher congestion level than the congestion level of the first processing cluster, increasing the congestion level of the first processing cluster; and
in accordance with a determination that the one or more historical congestion levels of the first processing cluster indicate a lower congestion level than the congestion level of the first processing cluster, decreasing the congestion level of the first processing cluster.

22. The method of claim 16, wherein the congestion level of the first processing cluster is determined based on an extent to which the plurality of data retrieval requests sent from the one or more processors in the first processing cluster to the cache are not satisfied by the cache, without regard to which of the one or more processors sent the plurality of data retrieval requests.

23. The method of claim 16, wherein determining the congestion level of the first processing cluster includes comparing the number of plurality of data retrieval requests, sent from the one or more processors in the first processing cluster to the cache, that are not satisfied by the cache to one or more cache miss thresholds.

24. The method of claim 23, wherein the one or more cache miss thresholds are determined based on a system congestion level of the device.

25. The method of claim 16, wherein the plurality of data retrieval requests include all data retrieval requests sent from the one or more processors to the cache within a predefined period of time.

26. The method of claim 16, wherein the first threshold quality is selected from a set of quality thresholds based on a system congestion level of the device.

27. The method of claim 16, further comprising, at the prefetch throttling circuitry:
in accordance with a determination that a congestion level of a second respective processor is below a processor congestion threshold, regardless of the congestion level of the first processing cluster, forgoing limiting prefetch requests from the second respective processor to the cache, wherein the congestion level of the second respective processor is determined based on an extent to which data retrieval requests sent from the second respective processor to the cache are not satisfied by the cache.

28. The method of claim 16, wherein causing the first respective processor of the one or more processors to limit prefetch requests to the cache to prefetch requests of at least the first threshold quality further comprises:
determining that a congestion level of the first respective processor is above a processor congestion threshold.

29. A non-transitory computer-readable medium, having instructions stored thereon for:
at an electronic device having a first processing cluster including one or more processors, a cache coupled to the one or more processors in the first processing cluster, and prefetch throttling circuitry coupled to the one or more processors in the first processing cluster, wherein the cache is configured to receive, from the one or more processors in the first processing cluster, a plurality of data retrieval requests including demand requests and prefetch requests:
determining a congestion level of the first processing cluster based on an extent to which the plurality of data retrieval requests sent from the one or more processors in the first processing cluster to the cache are not satisfied by the cache; and
in accordance with a determination that the congestion level of the first processing cluster satisfies first congestion criteria that require that the congestion level of the first processing cluster is above a first cluster congestion threshold, causing a first respective processor of the one or more processors to limit prefetch requests to the cache to prefetch requests of at least a first threshold quality; and
in accordance with a determination that the congestion level of the first processing cluster does not satisfy the first congestion criteria, forgoing causing the one or more processors to limit prefetch requests to the cache to prefetch requests of at least the first threshold quality

30. An apparatus for caching data caching at an electronic device having a first processing cluster including one or more processors, a cache coupled to the one or more processors in the first processing cluster, and prefetch throttling circuitry coupled to the one or more processors in the first processing cluster, wherein the cache is configured to receive, from the one or more processors in the first processing cluster, a plurality of data retrieval requests including demand requests and prefetch requests, the apparatus comprising:
means for determining a congestion level of the first processing cluster based on an extent to which the plurality of data retrieval requests sent from the one or more processors in the first processing cluster to the cache are not satisfied by the cache; and
means for in accordance with a determination that the congestion level of the first processing cluster satisfies first congestion criteria that require that the congestion level of the first processing cluster is above a first cluster congestion threshold, causing a first respective processor of the one or more processors to limit prefetch requests to the cache to prefetch requests of at least a first threshold quality; and
means for in accordance with a determination that the congestion level of the first processing cluster does not satisfy the first congestion criteria, forgoing causing the one or more processors to limit prefetch requests to the cache to prefetch requests of at least the first threshold quality.
